(19) United States
(12) Patent Application Publication
(10) Pub. No.: US 2018/0319993 A1
(43) Pub. Date: Nov. 8, 2018

(54) CONDUCTIVE NANOPARTICLE DISPERSION PRIMER COMPOSITION AND METHODS OF MAKING AND USING THE SAME

(71) Applicant: SABIC Global Technologies B.V., Bergen op Zoom (NL)

(72) Inventors: David Dean Clinnin, Newburgh, IN (US); Wei Feng, Shanghai (CN)

(21) Appl. No.: 15/775,520

(22) PCT Filed: Nov. 11, 2016
(86) PCT No.: PCT/US2016/061485

§ 371 Date: May 11, 2018

Related U.S. Application Data
(60) Provisional application No. 62/255,115, filed on Nov. 13, 2015.

(51) Int. Cl. C09D 5/00; C09D 135/02; C09D 4/00; H01B 1/12

(52) U.S. Cl. CPC C09D 5/002; H01B 1/124; C09D 4/00; C09D 135/02

(57) ABSTRACT

A method of curing a coating includes forming a primer coating from a composition for use in a conductive nanoparticle composition, wherein the composition comprises a multifunctional acrylate oligomer; an acrylate monomer; a photoinitiator; and a solvent; wherein the primer composition includes a total weight, wherein 5% to 20% of the total weight comprises the multifunctional acrylate oligomer, wherein 15% to 20% of the total weight comprises the acrylate monomer, wherein 1.5% to 6% of the total weight comprises the photoinitiator; and wherein 50 to 78% of the total weight comprises the solvent; applying the primer coating to a surface of a substrate to form a coated substrate; applying irradiation to the primer coating with an ultraviolet light lamp having a peak irradiance of at least 1500 milliWatts; and curing the coating.

### BACKGROUND

Coating processes can require treating a substrate prior to coating to improve properties between the coating and substrate such as adhesion, surface wetting, and compatibility. The use of a primer composition or other treatments such as plasma treatment or ultraviolet radiation treatment can be used to treat the substrate before coating. These treatments can be used in conductive coatings, which themselves can be useful in a variety of electronic devices. These coatings can provide a number of functions such as electromagnetic interference shielding and electrostatic dissipation. These coatings can be used in many applications including, but not limited to, touch screen displays, wireless electronic boards, photovoltaic devices, conductive textiles and fibers, organic light emitting diodes, electroluminescent devices, and electrophoretic displays, such as e-paper.

Primer stability can be a concern when forming conductive coatings, which can affect adhesion of a conductive coating to a substrate. Thus, there is a need in the art for a primer composition with better stability, which can assist in providing strong adhesion between a conductive coating and a substrate.

### BRIEF DESCRIPTION

A primer composition for use in a conductive nanoparticle dispersion, includes: a multifunctional acrylate oligomer; and an acrylate monomer; and a photoinitiator; and a solvent; wherein the primer composition includes a total weight, wherein 5% to 20% of the total weight comprises the multifunctional acrylate oligomer, wherein 15% to 20% of the total weight comprises the acrylate monomer, wherein 1.5% to 6% of the total weight comprises the photoinitiator; and wherein 50 to 78% of the total weight comprises the solvent.

A method of curing a coating includes forming a primer coating from a composition for use in a conductive nanoparticle composition, wherein the composition comprises a multifunctional acrylate oligomer; an acrylate monomer; a photoinitiator; and a solvent; wherein the primer composition includes a total weight, wherein 5% to 20% of the total weight comprises the multifunctional acrylate oligomer, wherein 15% to 20% of the total weight comprises the acrylate monomer, wherein 1.5% to 6% of the total weight comprises the photoinitiator; and wherein 50 to 78% of the total weight comprises the solvent; applying the primer coating to a surface of a substrate to form a coated substrate; applying irradiation to the primer coating with an ultraviolet light lamp having a peak irradiance of at least 1500 milliWatts; and curing the coating.

A conductive sheet or film includes a coated substrate, wherein the coated substrate includes a first surface and a second surface, wherein the primer coating is adhered to the first surface; and a conductive coating adjacent to the primer composition, wherein the conductive coating includes nanometer sized metal particles arranged in a network, and wherein the conductive coating has a surface resistance of less than or equal to 0.1 Ohm/sq.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 is an illustration of a cross-sectional view of a conductive sheet or film including a primer composition coating layer and a conductive coating transferred thereto.

FIG. 2 is an illustration of a cross-sectional view of a portion of a conductive sheet or film including a primer composition coating layer, a conductive coating transferred thereto, and a coated substrate.

FIG. 3 is an illustration of a flow chart of an embodiment of the method of preparing a conductive sheet or film.

FIGS. 4A-52B are images of the respective examples in Tables 4-13.

### DETAILED DESCRIPTION

Disclosed herein is a primer composition that can provide increased adhesion between a conductive coating and a substrate as compared to a different primer composition. For example, the primer composition can form a primer coating layer that can provide increased adhesion of a substrate to a coating by solving the various problems associated with residual solvent from the primer composition in the primer coating layer, which can cause porosity or solvent bubbling issues in the primer coating layer.

A primer composition for use in conductive nanoparticle dispersion can include a multifunctional acrylate oligomer, an acrylate monomer, an optional adhesion promoter, an optional surface additive, a photoinitiator, and a solvent. The primer composition can provide increased adhesion between a conductive coating and a substrate as compared to a different primer composition. The primer composition can include a total weight. The multifunctional acrylate oligomer can comprise 5% to 20% of the total weight. The acrylate monomer can comprise 15% to 20% of the total weight. The optional adhesion promoter can comprise 0.25% to 2% of the total weight. The optional surface additive can comprise 0.25% to 2% of the total weight. The photoinitiator can comprise 1.5% to 6% of the total weight. The solvent can comprise 50% to 78% of the total weight. The primer composition can form a primer composition coating layer that can assist in providing the desired adhesion between a conductive coating and a substrate.

Disclosed herein is a primer composition for use in a conductive nanoparticle dispersion. The primer composition can form a primer composition coating layer that can provide increased adhesion of a substrate to a coating by solving the various problems associated with residual solvent from the primer composition in the primer composition coating layer, which can cause porosity or solvent bubbling issues in the primer composition coating layer.

A primer composition for use in a conductive nanoparticle dispersion can include a multifunctional acrylate oligomer, an acrylate monomer, a photoinitiator, and a solvent. The primer composition can include a total weight. The multifunctional acrylate oligomer can comprise 5% to 20% of the total weight. The acrylate monomer can comprise 15% to 20% of the total weight. The photoinitiator can comprise 1.5% to 6% of the total weight. The solvent can comprise 50% to 78% of the total weight.

The primer composition coating layer can be disposed adjacent to a substrate. The primer composition coating layer can be disposed between a conductive coating and a surface of a substrate. The primer composition coating layer can adhere to the conductive coating and a surface of a substrate and can provide an adhesive force to connect the conductive coating adjacent to the substrate. The primer composition coating layer can be sandwiched between the conductive coating and the substrate, such that it is disposed adjacent to a surface of a substrate on one side and the conductive coating on the other side. The substrate can include a substrate coating. The primer composition coating layer can be adhered directly to a substrate surface. The primer composition coating layer can be adhered to the surface of a coating which is adhered to the surface of the substrate.

The primer composition can include a multifunctional acrylate oligomer and an acrylate monomer. The primer composition can include a photoinitiator. The multifunctional acrylate oligomer can include an aliphatic urethane acrylate oligomer, a pentaerythritol tetraacrylate, an aliphatic urethane acrylate, an acrylic ester, a dipentaerythritol dexaacrylate, an acrylated resin, a trimethylolpropane triacrylate (TMPTA), a dipentaerythritol pentaacrylate ester, or a combination comprising at least one of the foregoing. In an embodiment, the multifunctional acrylate oligomer can include DOUBLEMER™ 5272 (DM5272) (commercially available from Double Bond Chemical Ind., Co., LTD., of Taipei, Taiwan, R.O.C.) which includes an aliphatic urethane acrylate oligomer in an amount from 30 weight percent (wt. %) to 50 wt. % of the multifunctional acrylate and a pentaerythritol tetraacrylate in an amount from 50 wt. % to 70 wt. % of the multifunctional acrylate. The multifunctional acrylate oligomer can include GENOMER™ 4267 (commercially available from Rahn USA Corp.) which is an aliphatic urethane acrylate with a functionality of 2, SARTOMER™ CN981 commercially available from SARTOMER Americas) which is CN981 an aliphatic polyester/polyether based urethane diacrylate oligomer offering weathering properties coupled with an inherently low viscosity, SARTOMER™ SR399 (commercially available from SARTOMER Americas) which includes a dipentaerythritol pentaacrylate with abrasion resistance, flexibility with hardness, and fast cure response for ultraviolet and electron beam curing.

The primer composition can include a polymerization initiator to promote polymerization of the acrylate components. The polymerization initiator can include a photoinitiator that promotes polymerization of the composition components upon exposure to ultraviolet radiation.

The primer composition can include the multifunctional acrylate oligomer in an amount of 30 wt. % to 90 wt. % for example, 30 wt. % to 85 wt. %, or, 30 wt. % to 80 wt. %; the acrylate monomers in an amount of 5 wt. % to 65 wt. %, for example, 8 wt. % to 65 wt. %, or, 15 wt. % to 65 wt. %; and the photoinitiator in an amount of 0 wt. % to 10 wt. %, for example, 2 wt. % to 8 wt. %, or, 3 wt. % to 7 wt. %, wherein weight is based on the total weight of the primer composition coating. The multifunctional acrylate oligomer can include an aliphatic urethane acrylate oligomer and a pentaerythritol tetraacrylate, wherein the multifunctional acrylate oligomer includes a multifunctional acrylate oligomer weight, wherein 30% to 50% of the multifunctional acrylate oligomer weight comprises the aliphatic urethane acrylate oligomer, and wherein 50% to 70% of the multifunctional acrylate oligomer weight comprises the pentaerythritol tetraacrylate. An aliphatic urethane acrylate oligomer can include 2 to 15 acrylate functional groups, for example, 2 to 10 acrylate functional groups. The acrylate monomer (e.g., 1,6-hexanediol diacrylate, meth(acrylate) monomer) can include 1 to 5 acrylate functional groups, for example, 1 to 3 acrylate functional group(s). In an embodiment, the acrylate monomer can be 1,6-hexanediol diacrylate (HDDA).

The multifunctional acrylate oligomer can include a compound produced by reacting an aliphatic isocyanate with an oligomeric diol such as a polyester diol or polyether diol to produce an isocyanate capped oligomer. This oligomer can then be reacted with hydroxy ethyl acrylate to produce the urethane acrylate. The multifunctional acrylate oligomer can be an aliphatic urethane acrylate oligomer, for example, a wholly aliphatic urethane (meth)acrylate oligomer based on an aliphatic polyol, which is reacted with an aliphatic polyisocyanate and acrylated. In one embodiment, the multifunctional acrylate oligomer can be based on a polyol ether backbone. For example, an aliphatic urethane acrylate oligomer can be the reaction product of (i) an aliphatic polyol; (ii) an aliphatic polyisocyanate; and (iii) an end capping monomer capable of supplying reactive terminus. The polyol (i) can be an aliphatic polyol, which does not adversely affect the properties of the composition when cured. Examples include polyether polyols; hydrocarbon polyols; polycarbonate polyols; polyisocyanate polyols, and mixtures thereof. The multifunctional acrylate oligomer can include an aliphatic urethane tetraacrylate (i.e., a maximum functionality of 4) that can be diluted 20% by weight with an acrylate monomer, e.g., 1,6-hexanediol diacrylate (HDDA), tripropyleneglycol diacrylate (TPGDA), or trimethylolpropane triacrylate (TMPTA). A commercially available urethane acrylate that can be used in forming the primer composition coating can be EBECRYL™ 8405, EBECRYL™ 8311, or EBECRYL™ 8402, each of which is commercially available from Allnex.

Some commercially available oligomers which can be used in the primer composition can include, but are not limited to, multifunctional acrylates that are part of the following families: the PHOTOMER™ Series of aliphatic urethane acrylate oligomers from IGM Resins, Inc., St. Charles, Ill.; the Sartomer SR Series of aliphatic urethane acrylate oligomer from Sartomer Company, Exton, Pa.; the Echo Resins Series of aliphatic urethane acrylate oligomers from Echo Resins and Laboratory, Versailles, Mo.; the BR Series of aliphatic urethane acrylates from Bomar Specialties, Winsted, Conn.; and the EBECRYL™ Series of aliphatic urethane acrylate oligomers from Allnex. For example, the aliphatic urethane acrylates can be KRM8452 (10 functionality, Allnex), EBECRYL™ 1290 (6 functionality, Allnex), EBECRYL™ 1290N (6 functionality, Allnex), EBECRYL™ 512 (6 functionality, Allnex), EBECRYL™ 8702 (6 functionality, Allnex), EBECRYL™ 8405 (3 functionality, Allnex), EBECRYL™ 8402 (2 functionality, Allnex), EBECRYL™ 284 (3 functionality, Allnex), CN9010™ (Sartomer), CN9013™ (Sartomer), SR351 (Sartomer) or Laromer TMPTA (BASF), SR399 (Sartomer) dipentaerythritol pentaacrylate esters and dipentaerythritol hexaacrylate DPHA (Allnex), CN9010 (Sartomer).

Another component of the primer composition can be an acrylate monomer having one or more acrylate or methacrylate moieties per monomer molecule. The acrylate monomer can be mono-, di-, tri-, tetra- or penta-functional. In one embodiment, di-functional monomers are employed for the desired flexibility and adhesion of the coating. The monomer can be straight- or branched-chain alkyl, cyclic, or partially aromatic. The reactive monomer diluent can also comprise a combination of monomers that, on balance, result in a desired adhesion for a coating composition on the substrate, where the primer composition can cure to form a hard, flexible material having the desired properties.

The acrylate monomer can include monomers having a plurality of acrylate or methacrylate moieties. These can be mono-, di-, tri-, tetra- or penta-functional, specifically di-functional, in order to increase the crosslink density of the cured coating and therefore can also increase modulus without causing brittleness. Examples of polyfunctional monomers include, but are not limited, to C₆-C₁₂ hydrocarbon diol diacrylates or dimethacrylates such as 1,6-hexanediol diacrylate (HDDA) and 1,6-hexanediol dimethacrylate; tripropylene glycol diacrylate or dimethacrylate; neopentyl glycol diacrylate or dimethacrylate; neopentyl glycol propoxylate diacrylate or dimethacrylate; neopentyl glycol ethoxylate diacrylate or dimethacrylate; 2-phenoxylethyl (meth)acrylate; alkoxylated aliphatic (meth)acrylate; polyethylene glycol (meth)acrylate; lauryl (meth)acrylate, isodecyl (meth)acrylate, isobornyl (meth)acrylate, tridecyl (meth)acrylate; and mixtures comprising at least one of the foregoing monomers. For example, the acrylate monomer can be 1,6-hexanediol diacrylate (HDDA), alone or in combination with another monomer, such as tripropyleneglycol diacrylate (TPGDA), trimethylolpropane triacrylate (TMPTA), oligotriacrylate (OTA 480), or octyl/decyl acrylate (ODA). For example, the acrylate monomer can be polyethylene glycol acrylate. For example, the acrylate monomer can be a monofunctional methoxylate polyethylene glycol acrylate monomer, e.g., SARTOMER™ CD553 (commercially available from SARTOMER Americas), an ethoxylate trimethrylolpropane triacrylate, e.g., SARTOMER™ SR454 (commercially available from SARTOMER Americas), a trifunctional monomer of 3 mole propoxylated glyceryl triacrylate, e.g., SARTOMER™ SR 9020 (commercially available from SARTOMER Americas), or a polyethylene glycol (600) diacrylate, e.g., SARTOMER™ SR610 (commercially available from SARTOMER Americas).

Another component of the primer composition can be an adhesion promoter such as a hydroxy functional copolymer including 1-methoxy-2-propanol, e.g., BYK 4510 (commercially available from ALTANA). Another component of the primer composition can be a surface additive such as a cross-linking silicone containing surface additive, e.g., a polyether modified, acryl functional siloxane such as BYK UV3530 (commercially available from ALTANA). Another component of the primer composition can be a solvent. The solvent can include an alcohol such as, ethanol, ethyl acetate, isopropanol, isobutyl acetate, or a combination comprising at least one of the foregoing.

Another component of the primer composition can be a polymerization initiator such as a photoinitiator, wherein the photoinitiator is ultraviolet cured. The photoinitiator can provide reasonable cure speed without causing premature gelation of the primer composition. Further, it can be used without interfering with the optical clarity of the cured primer composition or primer composition coating layers made therefrom. Still further, the photoinitiator can be thermally stable, non-yellowing, and efficient. Photoinitiators can include, but are not limited to, the following: α-hydroxyketone; bis acyl phosphine; benzophenone; phenyl bis bis(2,4,6-trimethyl benzoyl; 1-hydroxy-cyclohexyl-phenyl-ketone, benzophenone, 2-hydroxy-2-methyl-1-phenyl-1-propanone; phosphine oxide; hydroxycyclohexylphenyl ketone; hydroxymethylphenylpropanone; dimethoxyphenylacetophenone; 2-methyl-1-[4-(methylthio)phenyl]-2-morpholinopropanone-1; 1-(4-isopropylphenyl)-2-hydroxy-2-methylpropan-1-one; 1-(4-dodecylphenyl)-2-hydroxy-2-methylpropan-1-one; 4-(2-hydroxyethoxy) phenyl-(2-hydroxy-2-propyl) ketone; diethoxyacetophenone; 2,2-di-sec-butoxyacetophenone; diethoxy-phenyl acetophenone; bis (2,6-dimethoxybenzoyl)-2,4-, 4-trimethylpentylphosphine oxide; 2,4,6-trimethylbenzoyldiphenylphosphine oxide; 2,4,6-trimethylbenzoylethoxyphenylphosphine oxide; and combinations comprising at least of the foregoing.

Exemplary photoinitiators can include phosphine oxide photoinitiators. Examples of such photoinitiators include the IRGACURE™, LUCIRIN™ and DAROCURE™ series of phosphine oxide photoinitiators available from BASF Corp.; the ADDITOL™ series from Allnex; and the ESACURE™ series of photoinitiators from Lamberti, s.p.a. Other useful photoinitiators include ketone-based photoinitiators, such as hydroxy- and alkoxyalkyl phenyl ketones, and thioalkylphenyl morpholinoalkyl ketones. Also desirable can be benzoin ether photoinitiators. Specific exemplary photoinitiators include bis(2,4,6-trimethylbenzoyl)-phenylphosphine oxide supplied as IRGACURE™ 819 by BASF or 2-hydroxy-2-methyl-1-phenyl-1-propanone supplied as ADDITOL HDMAP™ by Allnex or 1-hydroxy-cyclohexyl-phenyl-ketone supplied as IRGACURE™ 184 by BASF or RUNTECURE™ 1104 by Changzhou Runtecure chemical Co. Ltd, or 2-hydroxy-2-methyl-1-phenyl-1-propanone supplied as DAROCURE™ 1173 by BASF. A photoinitiator can include GENOCURE™ LBC, a benzophenone liquid photoinitiator blend commercially available from Rahn USA Corp. The photoinitiator can be chosen such that the curing energy is less than 2.0 Joules per square centimeter (J/cm²), and specifically less than 1.0 J/cm², when the photoinitiator is used in the designated amount.

The polymerization initiator can include peroxy-based initiators that can promote polymerization under thermal activation. Examples of useful peroxy initiators include benzoyl peroxide, dicumyl peroxide, methyl ethyl ketone peroxide, lauryl peroxide, cyclohexanone peroxide, t-butyl hydroperoxide, t-butyl benzene hydroperoxide, t-butyl peroctoate, 2,5-dimethylhexane-2,5-dihydroperoxide, 2,5-dimethyl-2,5-di(t-butylperoxy)-hex-3-yne, di-t-butylperoxide, t-butylcumyl peroxide, alpha,alpha′-bis(t-butylperoxy-m-isopropyl)benzene, 2,5-dimethyl-2,5-di(t-butylperoxy)hexane, dicumylperoxide, di(t-butylperoxy isophthalate, t-butylperoxybenzoate, 2,2-bis(t-butylperoxy)butane, 2,2-bis(t-butylperoxy)octane, 2,5-dimethyl-2,5-di(benzoylperoxy)hexane, di (trimethylsilyl)peroxide, trimethylsilylphenyltriphenylsilyl peroxide, and the like, and combinations comprising at least one of the foregoing polymerization initiators.

A primer composition coating layer as described herein can have an electrical resistivity of less than or equal to 75 ohms per square (Ω/sq), for example, less than or equal to 50 Ω/sq, for example, less than or equal to 25 Ω/sq, for example, less than or equal to 15 Ω/sq. A primer composition coating layer as described herein can have an electrical resistivity of 10 to 25 Ω/sq. Electrical resistivity generally refers to how strongly a material opposes the flow of electric current. A lower number implies increasing conductivity.

The present disclosure provides a method of curing a coating in an inert atmosphere, wherein the method includes forming a primer coating from a composition for use in a conductive nanoparticle composition, wherein the composition comprises a multifunctional acrylate oligomer; an acrylate monomer; a photoinitiator; and a solvent; wherein the primer composition includes a total weight, wherein 5% to 20% of the total weight comprises the multifunctional acrylate oligomer, wherein 15% to 20% of the total weight comprises the acrylate monomer, wherein 1.5% to 6% of the total weight comprises the photoinitiator; and wherein 50 to 78% of the total weight comprises the solvent. The primer coating is applied to a surface of a substrate to form a coated substrate. The coated substrate is subjected to irradiation with a microwave powered ultraviolet (UV) lamp, wherein the irradiation is applied in an inert atmosphere, and the coated substrate is cured. The inert atmosphere can include nitrogen, argon, helium, carbon dioxide, or a combination comprising at least one of the foregoing. The thickness of the primer coating can be 10 micrometers to 50 micrometers, for example, 20 micrometers to 40 micrometers, or 20 micrometers to 30 micrometers.

The substrate can be any shape. The substrate can have a first surface and a second surface. The substrate can include a polymer, a glass, or a combination of polymer and glass. The first surface of the substrate can comprise a first polymer. The second surface of the substrate can comprise a second polymer. The first surface of the substrate can be disposed opposite the second surface of the substrate. The first surface of the substrate can consist of the first polymer. The second surface of the substrate can consist of the second polymer. The first surface of the substrate can consist of the first polymer and the second surface of the substrate can consist of the second polymer. The first polymer and the second polymer can be co-extruded to form the substrate. The first polymer and the second polymer can be different polymers, e.g. can comprise different chemical compositions. The substrate can be flat and can include the first surface and the second surface where the second surface can be disposed opposite the first surface, such as co-extruded forming opposing sides of the substrate. The substrate can be flexible. The thickness of the substrate can be 150 micrometers to 250 micrometers, for example, 150 micrometers to 200 micrometers, or 150 micrometers to 175 micrometers.

The primer coating can be cured by an H-bulb, using various peak irradiance and using either a Microwave UV processor or an Arc lamp UV processor. The coated substrate can be subjected to irradiation (e.g., exposure) at an energy of 380 milliJoules (mJ) to 650 mJ, for example 400 mJ to 600 mJ, for example, 425 mJ to 475 mJ. Peak irradiance refers to the peak wattage of the lamp used. The primer can be peak irradiance sensitive. The coated substrate can be subjected to irradiation at a power of 1500 milliWatts (mW) to 2500 mW, for example, 1900 mW to 2200 mW, for example, 2000 mW to 2100 mW. The coated substrate can be cured for 60 seconds, 90 seconds, or 120 seconds. The curing temperature can be 125° C. to 200° C., for example 140° C. In addition, the coated substrate can be exposed to a temperature of 25° C. to 100° C. before irradiation. The exposure can be 20 to 100 seconds, for example, 30 to 90 seconds, 40 to 80 seconds, or 50 to 70 seconds.

The present disclosure provides a conductive sheet or film including the coated substrate and a conductive coating applied to the primer coating layer. The conductive coating can contain an electromagnetic shielding material. The conductive coating can include a conductive material. Conductive materials can include pure metals such as silver (Ag), nickel (Ni), copper (Cu), metal oxides thereof, combinations comprising at least one of the foregoing, or metal alloys comprising at least one of the foregoing, or metals or metal alloys produced by the Metallurgic Chemical Process (MCP) described in U.S. Pat. No. 5,476,535. Metals of the conductive coating can be nanometer sized, e.g., such as where 90% of the particles can have an equivalent spherical diameter of less than 100 nanometers (nm). The metal particles can be sintered to form a network of interconnected metal traces defining randomly shaped openings on the substrate surface to which it is applied. The sintering temperature of the conductive coating can be 300° C. which can exceed the heat deflection temperature of some substrate materials. After sintering, the surface resistance of the conductive coating can be less than or equal to 0.1 ohm per square (ohm/sq). The conductive coating can have a surface resistance of less than 1/10th of the surface resistance of an indium tin oxide coating. The conductive coating can be transparent.

Unlike networks formed of nanometer sized metal wires, the conductive network formed of nanometer sized metal particles can be bent without reducing the conductivity and/or increasing the electrical resistance of the conductive network. For example, networks of metal wires can separate at junctions when bent, which can reduce the conductivity of the wire network, whereas the metal network of nanometer sized particles can deform elastically without separating traces of the network, thereby maintaining the conductivity of the network.

The primer composition coating can be disposed adjacent to a surface of the substrate (e.g., dispersed across the surface of the substrate). The primer composition coating can abut a surface of the substrate. The primer composition coating can be disposed on a surface of a substrate. The primer composition coating can be applied to the conductive coating. The primer composition coating can at least partially surround the conductive coating. The conductive coating can be at least partially embedded in the primer composition coating, such that a portion of the primer composition coating can extend into an opening in the nano-metal network of the conductive coating.

A substrate can optionally include a substrate coating disposed on a surface of the substrate. The substrate coating can be disposed on two opposing surfaces of the substrate. The substrate coating can provide a protective portion to the substrate. The protective portion, such as an acrylic hard coat, can provide abrasion resistance to the underlying substrate. The protective portion can be disposed adjacent to a surface of the substrate. The protective portion can abut a surface of the substrate. The protective portion can be disposed opposite the conductive coating. The protective portion can include a polymer. In an embodiment, a substrate coating can include a polymeric coating offering good pencil hardness (e.g., 4-5H measured according to ASTM D3363 on polymethyl methacrylate or HB-F measured according to ASTM D3363 on polycarbonate) and chemical/abrasion resistance, together with desirable processing characteristics. For example, the substrate coating can include a coating such as a LEXAN™ OQ6DA film, commercially available from SABIC's Innovative Plastics Business or a similar acrylic based or silicon based coating, film, or coated film, which can provide enhanced pencil hardness, enhanced chemical resistance, variable gloss and printability, enhanced flexibility, and/or enhanced abrasion resistance. The coating can be 0.1 millimeter (mm) to 2 mm thick, for example, 0.25 mm to 1.5 mm, or, 0.5 mm to 1.2 mm thick. The coating can be applied on one or more sides of the substrate. For example, the substrate coating can include an acrylic hard coat.

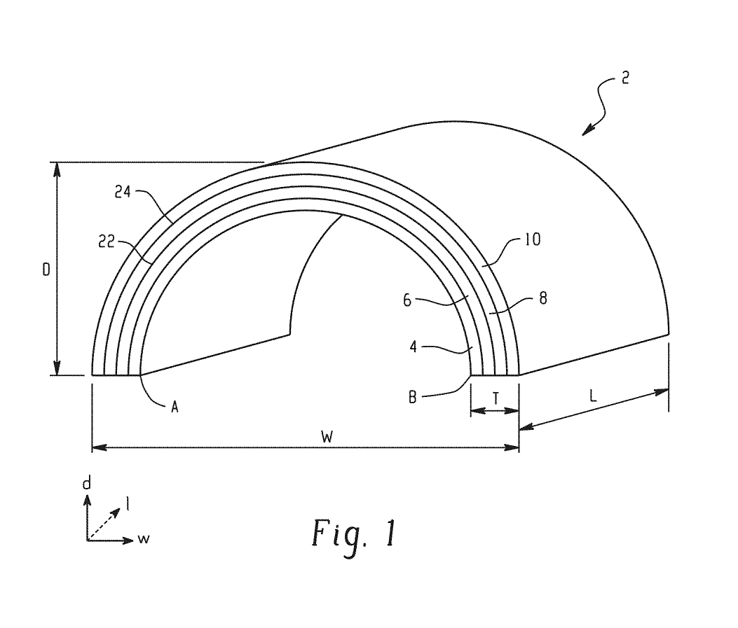

FIG. 1 is an illustration of a conductive sheet or film 2. The sheet or film 2 can include a conductive coating 4, a primer composition coating 6 (i.e., a primer composition coating layer), a substrate 8, and a protective portion 10. The sheet or film 2 can be bent and/or formed (e.g., extruded), such that the depth of the shape of the sheet or film, D, is greater than the total thickness, T, of the sheet or film 2. The electrical conductivity of the conductive sheet or film 32 can be measured from point A to point B. The substrate can include a first surface 22 and a second surface 24. The substrate 8 can include two polymers that are co-extruded. The substrate can include a first surface 22 comprising a first polymer and a second side 24 comprising a second polymer. The coextruded substrate can include a first surface 22 consisting of a first polymer and a second surface 24 consisting of a second polymer. The conductive coating 4 can be disposed adjacent to the first surface 22 of the substrate 8. The primer composition coating 6 can be applied directly to the first surface 22 of the substrate 8 or the primer composition coating 6 can be applied to a conductive coating 4. The primer composition coating 6 can be sandwiched between the conductive coating 4 and the first surface 22 of the substrate 8. The sheet or film 2 can be curved in at least one dimension, e.g., the w-axis dimension. The sheet or film 2 can be curved in at least two dimensions, e.g., the w-axis and h-axis dimensions. The sheet or film 2 can have a width, W, measured along a w-axis. The sheet or film 2 can have a depth, D, measured along a d-axis. The sheet or film 2 can have a length, L, measured along the 1-axis. The sheet or film 2 can be flexible such that the change in the electrical resistance (measured between point A to point B) can be less than or equal to 1 ohm when the integrated conductive film 2 is bent. The thickness, T, of the sheet or film 2 can be 0.05 mm to 25 mm, for example, 0.05 mm to 10 mm, or, 0.1 mm to 5 mm. The sheet or film 2 can be curved. The depth, D, can be larger than twice the total thickness, T, of the sheet or film 2. The sheet or film 2 can have a maximum depth anywhere along the film. The conductive coating 4 can be at least partially surrounded by portions of the primer composition coating 6, such that portions of the primer composition coating 6 can extend into openings in the nano-metal network of the conductive coating 4.

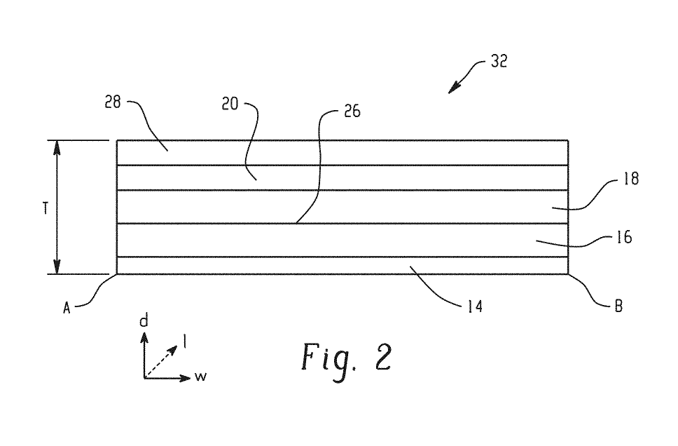

FIG. 2 is an illustration of a portion of a cross-section of a conductive sheet or film 32. The conductive sheet or film 32 can include a conductive coating 14, a primer composition coating 16, an optional first substrate coating 18, an optional second substrate coating 28, and a substrate 20. The electrical conductivity of the conductive sheet or film 32 can be measured from point A to point B. An optional first substrate coating 18 can be disposed adjacent to the substrate 20 such that the primer composition coating 16 can be adhered to a surface 26 of the optional first substrate coating 18, and adjacent to the substrate 20. The conductive coating 14 can be at least partially surrounded by portions of the primer composition coating 16, such that portions of the primer composition coating 16 can extend into openings in the nano-metal network of the conductive coating 14. The sheet or film 32 can include an optional second substrate coating 28 disposed on a surface opposing the surface that the optional first substrate coating 18 is disposed.

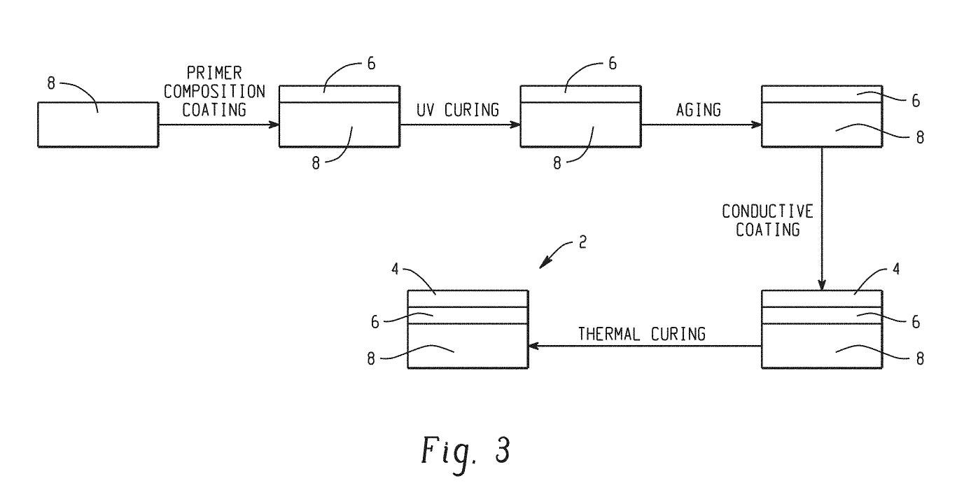

FIG. 3 is an illustration of an embodiment of a method of preparing the conductive sheet or film 2, wherein a substrate 8 is provided and the primer coating 6 is applied to a surface of the substrate 8. The primer layer is UV cured and aged, after which the conductive coating 4 is applied to the primer coating 6. The conductive coating 4 is thermal cured to form the conductive sheet or film 2. Alternatively, or in addition to, the primer compositon coating 6 can be applied to the substrate 8 or conductive coating 4, wherein the primer coating 6 is sandwiched in between the substrate 8 and the conductive coating 4, wherein the primer coating 6 is cured to adhere the layers together.

The primer composition coating layer can transmit greater than or equal to 50% (e.g. 50 percent transmittance) of incident visible light (e.g., electromagnetic radiation having a frequency of 430 THz to 790 THz), for example, 60% to 100%, or, 75% to 100%, for example 86̂. Transparency is described by two parameters, percent transmission and percent haze. Percent transmittance and percent haze for laboratory scale samples can be determined using ASTM D1003, Procedure A using CIE standard illuminant C using a Haze-Gard test device. ASTM D1003 (Procedure B, Spectrophotometer, using illuminant C with diffuse illumination with unidirectional viewing) defines percent transmittance as:

$$\% T = ( \frac{I}{{I}_{O}} ) \times 100 \% \qquad [ 1 ]$$

wherein: I is the intensity of the light passing through the test sample and Iₒ is the Intensity of incident light.

A primer composition coating layer can have a haze value of less than or equal to 5% as measured according to ASTM D1003, Procedure A using CIE standard illuminant C, for example, the haze value can be less than or equal to 3%, for example, the haze value can be less than or equal to 2.5%. A conductive sheet or film including the primer composition coating layer can have a haze of less than or equal to 6% as measured according to ASTM D1003 Procedure A using CIE standard illuminant C, for example, less than or equal to 5%, for example, less than or equal to 2.5%. A conductive sheet or film including the primer composition coating layer can have a transmittance of greater than or equal to 80%, for example, greater than or equal to 85%, for example, greater than or equal to 86%, for example, greater than or equal to 87% of incident light having a frequency of 430 THz to 790 THz as measured according to ASTM D1003 Procedure A using CIE standard illuminant C.A conductive sheet or film including the primer composition coating layer can have a pencil hardness of greater than or equal to H as measured according to ASTM D3363 using a Mitsubishi Uni pencil having a 1 kilogram loading.

The primer composition formed into a primer composition coating can be cured. Curing the primer composition coating can include waiting, heating, drying, exposing to electromagnetic radiation (e.g., electromagnetic radiation (EMR) in the UV spectrum), or a combination of one of the foregoing.

A conductive sheet or film can include a substrate including a first surface and a second surface, a primer composition coating layer as described herein adhered to the first surface, and a conductive coating adjacent to the primer composition coating layer, wherein the conductive coating includes nanometer sized metal particles arranged in a network, and wherein the conductive coating has a surface resistance of less than or equal to 0.1 Ohm/sq.

A polymer of a conductive sheet, film, or substrate, or used in the manufacture of the conductive sheet, film, or substrate, (e.g., substrate, primer composition coating layer, and optional substrate coating), can include a thermoplastic resin, a thermoset resin, glass, or a combination comprising at least one of the foregoing.

Possible thermoplastic resins include, but are not limited to, oligomers, polymers, ionomers, dendrimers, copolymers such as graft copolymers, block copolymers (e.g., star block copolymers, random copolymers, and the like) or a combination comprising at least one of the foregoing. Examples of such thermoplastic resins include, but are not limited to, polycarbonates (e.g., blends of polycarbonate (such as, polycarbonate-polybutadiene blends, copolyester polycarbonates)), polystyrenes (e.g., copolymers of polycarbonate and styrene, polyphenylene ether-polystyrene blends), polyimides (PI) (e.g., polyetherimides (PEI)), acrylonitrile-styrene-butadiene (ABS), polyalkylmethacrylates (e.g., polymethylmethacrylates (PMMA)), polyesters (e.g., copolyesters, polythioesters), polyolefins (e.g., polypropylenes (PP) and polyethylenes, high density polyethylenes (HDPE), low density polyethylenes (LDPE), linear low density polyethylenes (LLDPE)), polyethylene terephthalate (PET), polyamides (e.g., polyamideimides), polyarylates, polysulfones (e.g., polyarylsulfones, polysulfonamides), polyphenylene sulfides, polytetrafluoroethylenes, polyethers (e.g., polyether ketones (PEK), polyether etherketones (PEEK), polyethersulfones (PES)), polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidones, polycarboranes, polyoxabicyclononanes, polydibenzofurans, polyphthalamide, polyacetals, polyanhydrides, polyvinyls (e.g., polyvinyl ethers, polyvinyl thioethers, polyvinyl alcohols, polyvinyl ketones, polyvinyl halides, polyvinyl nitriles, polyvinyl esters, polyvinylchlorides), polysulfonates, polysulfides, polyureas, polyphosphazenes, polysilazanes, polysiloxanes, fluoropolymers (e.g., polyvinyl fluourides (PVF), polyvinylidene fluorides (PVDF), fluorinated ethylene-propylenes (FEP), polyethylene tetrafluoroethylenes (ETFE)), polyethylene naphthalates (PEN), cyclic olefin copolymers (COC), or a combination comprising at least one of the foregoing.

More particularly, a thermoplastic resin can include, but is not limited to, polycarbonate resins (e.g., LEXAN™ resins, including LEXAN™ CFR resins, commercially available from SABIC's Innovative Plastics business), polyphenylene ether-polystyrene resins (e.g., NORYL™ resins, commercially available from SABIC's Innovative Plastics business), polyetherimide resins (e.g., ULTEM™ resins, commercially available from SABIC's Innovative Plastics business), polybutylene terephthalate-polycarbonate resins (e.g., XENOY™ resins, commercially available from SABIC's Innovative Plastics business), copolyestercarbonate resins (e.g., LEXAN™ SLX resins, commercially available from SABIC's Innovative Plastics business), or a combination comprising at least one of the foregoing resins. Even more particularly, the thermoplastic resins can include, but are not limited to, homopolymers and copolymers of a polycarbonate, a polyester, a polyacrylate, a polyamide, a polyetherimide, a polyphenylene ether, or a combination comprising at least one of the foregoing resins. The polycarbonate can comprise copolymers of polycarbonate (e.g., polycarbonate-polysiloxane, such as polycarbonate-polysiloxane block copolymer, polycarbonate-dimethyl bisphenol cyclohexane (DMBPC) polycarbonate copolymer (e.g., LEXAN™ DMX and LEXAN™ XHT resins commercially available from SABIC's Innovative Plastics business), polycarbonate-polyester copolymer (e.g., XYLEX™ resins, commercially available from SABIC's Innovative Plastics business),), linear polycarbonate, branched polycarbonate, end-capped polycarbonate (e.g., nitrile end-capped polycarbonate), or a combination comprising at least one of the foregoing, for example, a combination of branched and linear polycarbonate.

“Polycarbonate” as used herein means a polymer or copolymer having repeating structural carbonate units of the formula

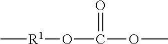

wherein at least 60 percent of the total number of R¹ groups are aromatic, or each R¹ contains at least one C₆₋₃₀ aromatic group. Polycarbonates and their methods of manufacture are known in the art, being described, for example, in WO 2013/175448 A1, US 2014/0295363, and WO 2014/072923. Polycarbonates are generally manufactured from bisphenol compounds such as 2,2-bis(4-hydroxyphenyl) propane (“bisphenol-A” or “BPA”), 3,3-bis(4-hydroxyphenyl) phthalimidine, 1,1-bis(4-hydroxy-3-methylphenyl)cyclohexane, or 1,1-bis(4-hydroxy-3-methylphenyl)-3,3,5-trimethylcyclohexane, or a combination comprising at least one of the foregoing bisphenol compounds can also be used. In a specific embodiment, the polycarbonate is a homopolymer derived from BPA; a copolymer derived from BPA and another bisphenol or dihydroxy aromatic compound such as resorcinol; or a copolymer derived from BPA and optionally another bisphenol or dihydroxyaromatic compound, and further comprising non-carbonate units, for example aromatic ester units such as resorcinol terephthalate or isophthalate, aromatic-aliphatic ester units based on C₆₋₂₀ aliphatic diacids, polysiloxane units such as polydimethylsiloxane units, or a combination comprising at least one of the foregoing.

A polymer of a conductive sheet, film, or substrate, or used in the manufacture of the conductive sheet, film, or substrate, (e.g., substrate, primer composition coating layer, and optional substrate coating), can include various additives ordinarily incorporated into polymer compositions of this type, with the proviso that the additive(s) are selected so as to not significantly adversely affect the desired properties of the polymeric composition. Such additives can be mixed at a suitable time during the mixing of the components for forming the composition. Exemplary additives include fillers, reinforcing agents, antioxidants, heat stabilizers, light stabilizers, ultraviolet (UV) light stabilizers, plasticizers, lubricants, mold release agents, antistatic agents, colorants such as titanium dioxide, carbon black, and organic dyes, surface effect additives, radiation stabilizers, flame retardants, and anti-drip agents. A combination of additives can be used, for example a combination of a heat stabilizer, mold release agent, and ultraviolet light stabilizer. The total amount of additives (other than any impact modifier, filler, or reinforcing agents) is generally 0.01 to 5 wt. %, based on the total weight of the composition.

The substrate can include polycarbonate. The substrate can include poly(methyl methacrylate) (PMMA). The substrate can include coextruded polycarbonate and poly(methyl methacrylate) (PMMA). The substrate can include coextruded polycarbonate and poly(methyl methacrylate) (PMMA) where a first surface of the substrate consists of polycarbonate and a second surface of the substrate consists of PMMA. The substrate can include polyethylene. The substrate can include glass. The substrate can include polycarbonate, poly(methyl methacrylate) (PMMA), polyethylene, glass, or a combination comprising at least one of the foregoing. The primer composition coating can be applied to a surface of the substrate comprising polycarbonate. The primer composition coating can be applied to a surface of the substrate consisting of polycarbonate. The primer composition coating can be disposed between the conductive coating and a surface of the substrate comprising polycarbonate. The primer composition coating can be disposed between the conductive coating and a surface of the substrate consisting of polycarbonate.

### EXAMPLES

Several components of the primer compositions disclosed herein were tested for reactivity. Table 1 lists the reactivity formulations and tests conducted under an ARC UV lamp, while Table 3 lists the reactivity formulations and tests conducted under Fusion H bomb UV. Table 2 lists the ARC UV lamp properties. In Table 1, P means pass and means a non-tacky surface when touched with a finger, F means the sample failed and had a tacky surface when touch with a finger, G means good reactivity, VP means very poor and no reactivity. In these examples, a 70% monomer/oligomer mixture plus 30% HDDA and 4% photoinitiator were used to make the samples. A bar coating was used to place the primer composition coating on a polycarbonate film. The primer composition coating had a thickness of about 4 μm. The film was immediately cured and then tested for a tacky/non-tacky surface. Cure times depend on the line speed (e.g., with a higher line speed there is a shorter time for UV curing and vice versa for a slower line speed). The materials listed in Tables 1 and 3 have been previously described herein and are commercially available components.

As can be seen from Table 1, Exp. No. 1, 2, 4, 5, 8, 10, and 11 all demonstrated good reactivity. In Table 3, the same Exp. Nos. demonstrated acceptable anti-scratch properties of less than 40%.

TABLE 1
Reactivity Formulations and Tests under ARC UV

| | | | | | | Exp. No. | | | | | |
|---|---|---|---|---|---|---|---|---|---|---|---|
| | | | | | | 1 | 2 | 3 | 4 | 5 | 6 |
| | | | | | | Monomer/Oligomer | | | | | |
| UV Intensity and Energy of Arc UV | | | | | | | | | | Genomer | Genomer |
| and Fusion UV | | | | | | DPHA | CN9010NS | SR506 | CN9001 | 4267 | 4297 |
| ARC UV | UVA | UVB | UVC | UVV | Reactivity | 70/30 HDDA, adding 4% Irgacure 184 (7 g oligomer, | | | | | |
| lamp | | | | | | 3 g HDDA, 0.4 g formulation Irgacure 184) | | | | | |
| Intensity | 334 | 240 | 71 | 213 | Reactivity under ARC UV | | | | | | |
| (mw/cm²) | | | | | | | | | | | |
| Energy | 233 | 180 | 53 | 171 | 9.5 m/min | P | P | F | P | P | F |
| (mJ/cm²) @ | | | | | | | | | | | |
| 9.5 m/min | | | | | | | | | | | |
| 7.7 m/min | 261 | 215 | 64 | 206 | 7.7 m/min | | | F | | | F |
| 3.6 m/min | 520 | 416 | 127 | 392 | 3.6 m/min | | | F | | | F |
| 1.7 m/min | 996 | 823 | 264 | 719 | 1.7 m/min | | | P | | | 1st F, |
| | | | | | | | | | | | 2nd, F |

| | | | | | | |
|---|---|---|---|---|---|---|
| Reactivity Summary | G | G | VP | G | G | VP |

| | | | | | | Exp. No. | | | | | |
|---|---|---|---|---|---|---|---|---|---|---|---|
| | | | | | | 7 | 8 | 9 | 10 | 11 | 12 |
| | | | | | | Monomer/Oligomer | | | | | |
| UV Intensity and Energy of Arc UV | | | | | | | | | | Photomer | |
| and Fusion UV | | | | | | SR9020 | SR344 | SR454 | SR610 | 6892 | CD553* |
| ARC UV | UVA | UVB | UVC | UVV | Reactivity | 70/30 HDDA, adding 4% Irgacure 184 (7 g oligomer, | | | | | |
| lamp | | | | | formulation | 3 g HDDA, 0.4 g formulation Irgacure 184) | | | | | |
| Intensity | 334 | 240 | 71 | 213 | Reactivity under ARC UV | | | | | | |
| (mw/cm²) | | | | | | | | | | | |
| Energy | 233 | 180 | 53 | 171 | 9.5 m/min | F | P | F | P | P | F |
| (mJ/cm²) @ | | | | | | | | | | | |
| 9.5 m/min | | | | | | | | | | | |
| 7.7 m/min | 261 | 215 | 64 | 206 | 7.7 m/min | F | | F | | | F |
| 3.6 m/min | 520 | 416 | 127 | 392 | 3.6 m/min | F | | F | | | F |
| 1.7 m/min | 996 | 823 | 264 | 719 | 1.7 m/min | 1st | | P | | | F |
| | | | | | | F, G | | | | | |
| | | | | | | 2nd P | | | | | |

| | | | | | |
|---|---|---|---|---|---|
| Reactivity Summary | VP | G | VP | G | G |

*P = Pass, F = Fail, G = Good, VP = Very Poor

TABLE 2
ARC UV Lamp Properties

| ARC UV lamp | UVA | UVB | UVC | UVV |
|---|---|---|---|---|
| Intensity (mW/cm²) | 334 | 240 | 71 | 213 |
| Energy (mJ/cm²) @ 9.5 m/min | 233 | 180 | 53 | 171 |

TABLE 3
Reactivity Formulations and Tests under Fusion H bomb UV

| | | | | | | Exp. No. | | | | | |
|---|---|---|---|---|---|---|---|---|---|---|---|
| | | | | | | 1 | 2 | 3 | 4 | 5 | 6 |
| | | | | | | Monomer/Oligomer | | | | | |
| UV Intensity and Energy of Arc UV | | | | | | | | | | Genomer | Genomer |
| and Fusion UV | | | | | | DPHA | CN9010NS | SR506 | CN9001 | 4267 | 4297 |
| Fusion UV | UVA | UVB | UVC | UVV | | | | | | | |
| lamp | | | | | | | | | | | |
| Intensity | 1768 | 1298 | 253 | 2005 | Reactivity under Fusion H bomb UV | | | | | | |
| (mW/cm²) | | | | | | | | | | | |
| Energy | 295 | 239 | 51 | 355 | 11.6 m/min | P | P | F | P | P | F |
| (mJ/cm²) @ | | | | | | | | | | | |
| 11.6 m/min | | | | | | | | | | | |
| 9.5 m/min | 369 | 302 | 67 | 452 | 9.5 m/min | | | F | | | F |
| 7 m/min | 480 | 377 | 83 | 579 | 7 m/min | | | F | | | F |
| 4 m/min | 911 | 717 | 154 | 1080 | 4 m/min | | | 1st F, | | | 1st F, |
| | | | | | | | | 2nd P | | | 2nd P |

| | | | | | | |
|---|---|---|---|---|---|---|
| Reactivity Summary | | | | | | |
| Anti-scratch (haze increase after 20 cycles linear | 8.0% | 6.8% | 54.5% | 19.1% | 39.3% | 20.9% |
| taber using 0000 steel wool) | | | | | | |
| Water contact angle | 58.9 | 64.8 | 77.3 | 79.3 | 80.6 | 70.4 |

| | | | | | | Exp. No. | | | | | |
|---|---|---|---|---|---|---|---|---|---|---|---|
| | | | | | | 7 | 8 | 9 | 10 | 11 | 12 |
| | | | | | | Monomer/Oligomer | | | | | |
| UV Intensity and Energy of Arc UV | | | | | | | | | | Photomer | |
| and Fusion UV | | | | | | SR9020 | SR344 | SR454 | SR610 | 6892 | CD553* |
| Fusion UV | UVA | UVB | UVC | UVV | | | | | | | |
| lamp | | | | | | | | | | | |
| Intensity | 1768 | 1298 | 253 | 2005 | Reactivity under Fusion H bomb UV | | | | | | |
| (mW/cm²) | | | | | | | | | | | |
| Energy | 295 | 239 | 51 | 355 | 11.6 m/min | F | P | F | P | P | F |
| (mJ/cm²) @ | | | | | | | | | | | |
| 11.6 m/min | | | | | | | | | | | |
| 9.5 m/min | 369 | 302 | 67 | 452 | 9.5 m/min | F | | P | | | F |

| | | | | | | | |
|---|---|---|---|---|---|---|---|
| 7 m/min | 480 | 377 | 83 | 579 | 7 m/min | P | F |
| 4 m/min | 911 | 717 | 154 | 1080 | 4 m/min | | F |

| | | | | | | |
|---|---|---|---|---|---|---|
| Reactivity Summary | | | | | | |
| Anti-scratch (haze increase after 20 cycles linear | 13.1% | 49.7% | 9.1% | 50.8% | 20.8% | >70% |
| taber using 0000 steel wool) | | | | | | |
| Water contact angle | 53.6 | | | | | 34 |

*CD553: seems the surface is always sticky due to its hydrophilic nature.

The following examples are directed to the application of the primer coating to a substrate. Adhesion between the primer coating layer and a polycarbonate substrate layer can be a function of swelling (or diffusion) of the primer coating layer into the polycarbonate layer, wherein the diffusion promotes chain entanglement anchorage of the primer coating layer to the polycarbonate layer upon curing the primer layer. However, too much primer coating diffusion into the substrate results in an increase in haze, indicating excessive swelling from the solvent or the monomers in the primer coating layer.

In addition, retained solvent in the primer layer results in defects in the primer layer. For example, solvent penetration is used to describe the effect of the solvent diffusion through the primer layer to the polycarbonate film, which results in an increase in haze. Specifically, residual solvent in the dried primer coating layer at the point of UV curing can cause porosity or solvent popping in the primer coating layer, which may reduce the chemical resistance of the primer layer to the toluene encountered in the conductive layer emulsion package subsequently applied.

To reduce the amount of retained solvent in the primer coating layer, faster evaporating solvent packages, such as those consisting of ethyl acetate and isobutyl acetate (70:30 to 80:20 volume ratio), can be used. Also, increasing the coating thickness increased the diffusion time for the solvent into the polycarbonate layer. In addition, the solvent can be evaporated in the drying process before reaching the polycarbonate film surface. A further method to reduce the amount of retained solvent is to use a slower line speed during the application of the primer coating to the substrate in order to increase the dwell time in the drier prior to UV processing, wherein the longer dwell time aids in further solvent evaporation. Tables 4-7 illustrate examples varying the coating speed and aging times.

Specifically, Tables 4-7 illustrate various examples of the application of a primer coating to a substrate. The primer coating used in all of the examples, referred to as PCC-1, includes an aliphatic urethane dimethacrylate, a monofunctional methoxylated PEG acrylate monomer, an ethoxylated trimethylolpropane triacrylate, monomers (M320 and M286 are what kind of monomers?), an acid functional silane, a silicone surface additive of polyether modified acryl functional polydimethylsiloxide, an adhesion promoter, a photoinitiator, and ethanol. To achieve a 2 micrometer (μm) thick primer coating, the wet primer coating composition was applied at a thickness of 6 μm. The primer coating was coated on a 178 μm (0.178 mm) polycarbonate substrate (e.g., LEXAN™ 8010). The primer coating was coated at 2, 4, and 6 m/min using an Arc lamp at 1300 mW with 260 mJ. The resulting films were subjected to a stability of 25 kg for 24 and 48 hours.

The conductive coating was then applied to the cured primer layer and subsequently thermally cured. The conductive coating used is commercially available from CIMA (SANTE™) which uses self-aligning nano-technology to obtain a silver network on a substrate. The percent transmission of SANTE™ is 81.9%, the percent haze is 4.27, and the resistance is 47.1Ω.

In the following examples, haze was tested according to ASTM D1003 procedure A using CIE standard illuminant C using a Haze-Gard test device. The relationship between conductive film elongation percentage and surface resistivity was characterized by a Dynamic Mechanical Analysis (DMA) method. The conductive film was cut into a 5 mm by 30 mm sample, then fixed on the holders of the DMA Instrument (TA Q800). The temperature was then increased to 130° C., then the film was stretched under a certain force and the surface resistance (R) measured after a certain stretch.

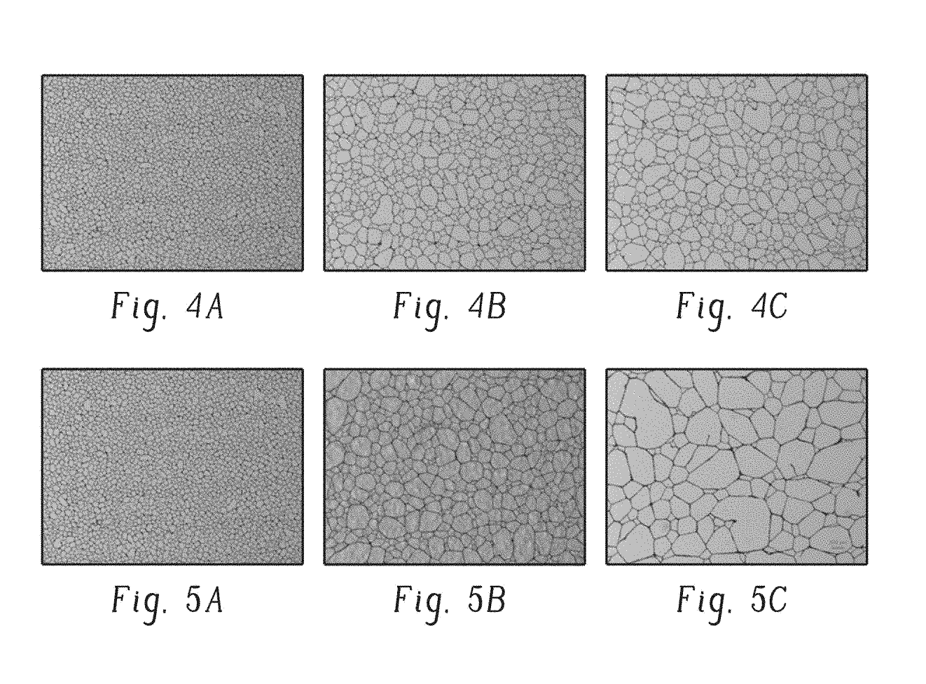

In Tables 4-7, “T %” refers to percent transmittance, “H %” refers to percent haze, and “R” refers to surface resistance. “OL” in Table 7 refers to overload (i.e., infinite resistance, meaning a greater amount than the meter can measure, where meters generally measure up to 1,000 Ω/sq.). The figures refer to the set of photos for each coating speed for each time elapsed. For example, FIGS. 4A-4C correspond to a time elapsed of zero minutes, wherein FIG. 4A corresponds to the coating rate of 2 m/min, FIG. 4B corresponds to the coating rate of 4 m/min, and FIG. 4C corresponds to the coating of 6 m/min. Similarly, for example, FIGS. 5A-5C correspond to a time elapsed of one minute at 140° C., wherein FIG. 5A corresponds to the coating rate of 2 m/min, FIG. 5B corresponds to the coating rate of 4 m/min, and FIG. 5C corresponds to the coating of 6 m/min. The time elapsed indicates the amount of time that passed before the examples were coated with the conductive coating layer and subsequently subjected to transmission, haze, and resistance testing.

TABLE 4

| | Coating Speed | | | | | | | | | |
|---|---|---|---|---|---|---|---|---|---|---|
| Time | 2 (m/min) | | | 4 (m/min) | | | 6/(m/min) | | | |
| Elapsed | T % | H % | R (Ω) | T % | H % | R(Ω) | T % | H % | R (Ω) | FIGS. |
| 0 | 74.1 | 9.1 | 30 | 81.4 | 5.4 | 25 | 83.8 | 3.7 | 25 | 4A-4C |
| 1 min @ | 75.9 | 8.3 | 26 | 85.4 | 3 | 21 | 85.5 | 3.1 | 26 | 5A-5C |
| 140° C. | | | | | | | | | | |
| 24 | 76.4 | 8 | 24 | 82.7 | 4.4 | 24 | 84.3 | 3.2 | 23 | 6A-6C |
| hours | | | | | | | | | | |
| 48 | 76.6 | 8.1 | 22 | 84.2 | 3.7 | 25 | 85.4 | 2.5 | 32 | 7A-7C |
| hours | | | | | | | | | | |

TABLE 5

| | Coating Speed | | | | | | | | | | | |
|---|---|---|---|---|---|---|---|---|---|---|---|---|
| | 8 (m/min) | | | 9 (m/min) | | | 10 (m/min) | | | 11.5 (m/min) | | |
| Time | | | R | | | | | | R | | | R |
| Elapsed | T % | H % | (Ω) | T % | H % | R (Ω) | T % | H % | (Ω) | T % | H % | (Ω) |
| 0 | 84.6 | 3.2 | 40 | 84.5 | 4 | 70 | 85 | 5.3 | 65 | 84.1 | 20 | 26 |

| | | | | |
|---|---|---|---|---|
| Solvent | Partial | Partial | Penetration | Penetration |
| | Penetration | Penetration | | |
| FIGS. | 8A | 8B | 8C | 8D |

TABLE 6

| | Coating Speed | | | | | | | | | | | |
|---|---|---|---|---|---|---|---|---|---|---|---|---|
| | 6 (m/min) | | | 8 (m/min) | | | 9 (m/min) | | | 10 (m/min) | | |
| Time | | | R | | | | | | R | | | R |
| Elapsed | T % | H % | (Ω) | T % | H % | R (Ω) | T % | H % | (Ω) | T % | H % | (Ω) |

| | | | |
|---|---|---|---|
| 0 | 85.2 | 10 | 42 |

| | | | | |
|---|---|---|---|---|
| Solvent | Partial | Partial | Penetration | Penetration |
| | Penetration | Penetration | | |
| FIGS. | 9A | 9B | 9C | 9D |

TABLE 7

| Time Elapsed | | | | | | | | | | | |
|---|---|---|---|---|---|---|---|---|---|---|---|
| 1 min 140° C. | | | 0 | | | 0 | | | 24 hours | | |
| Curing | | | | | | | | | | | |
| 8 mpm | | | 2 mpm | | | 8 mpm | | | 8 mpm | | |
| | | R | | | | | | R | | | R |
| T % | H % | (Ω) | T % | H % | R (Ω) | T % | H % | (Ω) | T % | H % | (Ω) |
| 86.2 | 1.3 | OL | 80.2 | 5.6 | 25 | 85.2 | 1.9 | OL | 87 | 1.5 | O: |

| | | | | |
|---|---|---|---|---|
| Adhesion | Tacky | NG | NG | NG |
| FIGS. | 10A | 10B | 10C | 10D |

As shown in Table 4, the curing speed increases the cells are larger and the film performance improves. For example, curing the primer formulation at 4 and 6 m/min resulted in acceptable transmittance and resistance values. A curing speed of 2 m/min resulted in a stable primer formulation but small cell size and less optimal optics. However, as shown in Tables 5-7, curing times greater than 8 m/min result in solvent penetration through the primer and an increase in haze.

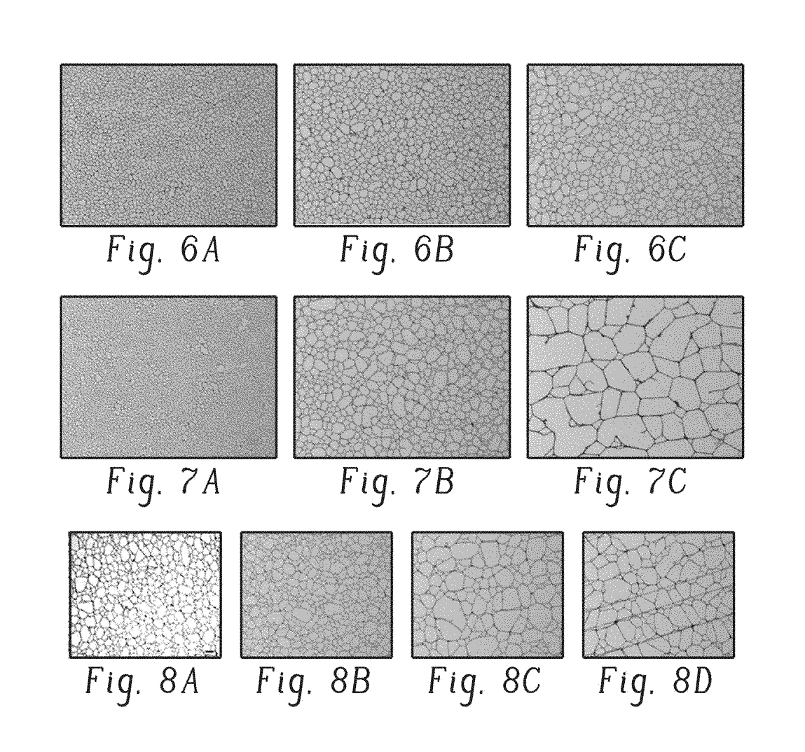

It can been seen, for example, by comparing FIGS. 4B, 5B, and 6B, that the primer changes with time, and that as the radiation density decreases the cell size increases. Because the cell size changed in 24 hours under pressure, it is concluded that the solvent is not solely responsible for the stability of the primer. Further, as shown in Table 7, a curing of 8 mps is not optimal owing to the result of no adhesion and no measurable sheet resistance.

Conductive sheets or films for the following examples in Tables 8-13 were prepared by applying the primer coating PCC-1 at 12 micrometers wet to result in a thickness of 2 or 4 micrometers dry, to a 0.178 mm polycarbonate substrate having a protective coating (i.e., the primer). The wet primer coating was applied at 12 μm to result in a 4 μm dry thickness. The substrate with the primer coating is subjected to a drying oven at a temperature of 60° C. for a duration of 60 seconds, after which the sample enters the UV processor for curing. The primer coating was cured by an H-bulb, but at various peak irradiance and using either a Microwave UV (having a high intensity light with a peak irradiance of 2000-2200 mW) processor or an Arc lamp (having an intensity of 600 mW) UV processor, as indicated in the tables. When an Arc lamp was used, it can be desirable to apply the primer coating in an inert environment. The settings of the UV processor are in terms of milliJoules and milliWatts (mJ/mW) and a 60 second flash at 50° C.-60° C. was performed before UV exposure. All samples were cured for 1 minute at 120-140° C. after the sample has been UV processed to accelerate aging of cured primer.

The conductive coating was then applied to the primer layer at a thickness of 25 μm and subsequently thermally cured. The conductive coating used is commercially available from CIMA (SANTE™) which uses self-aligning nano-technology to obtain a silver network on a substrate. The percent transmission of SANTE™ is 81.9%, the percent haze is 4.27, and the resistance is 47.1Ω.

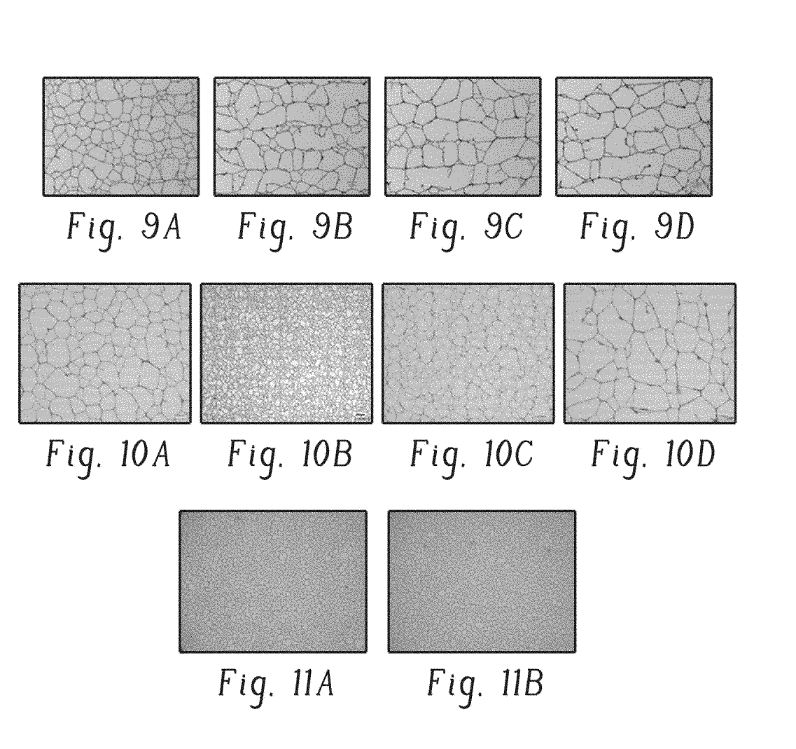

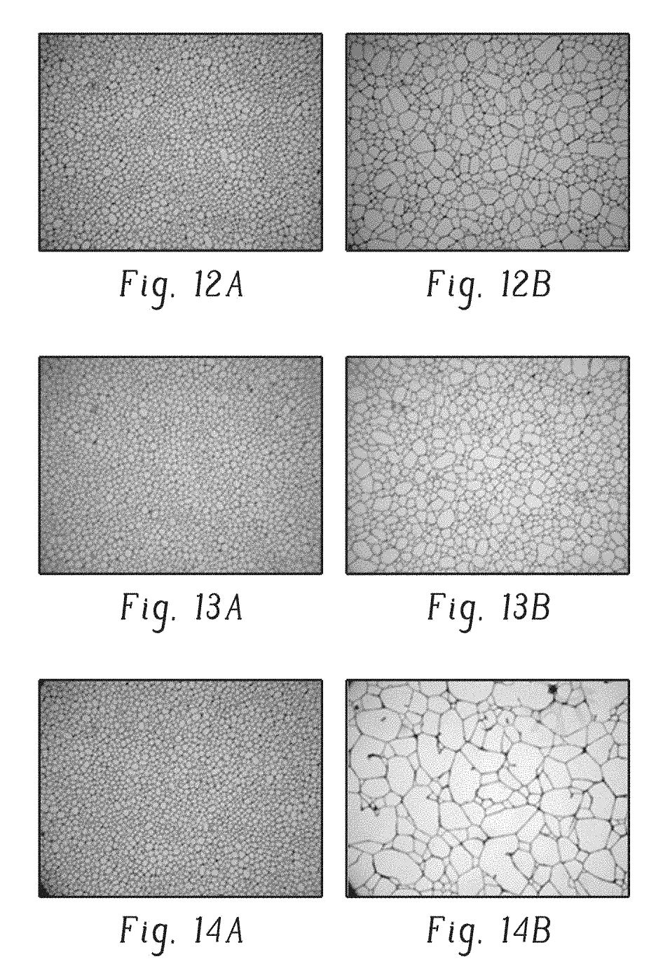

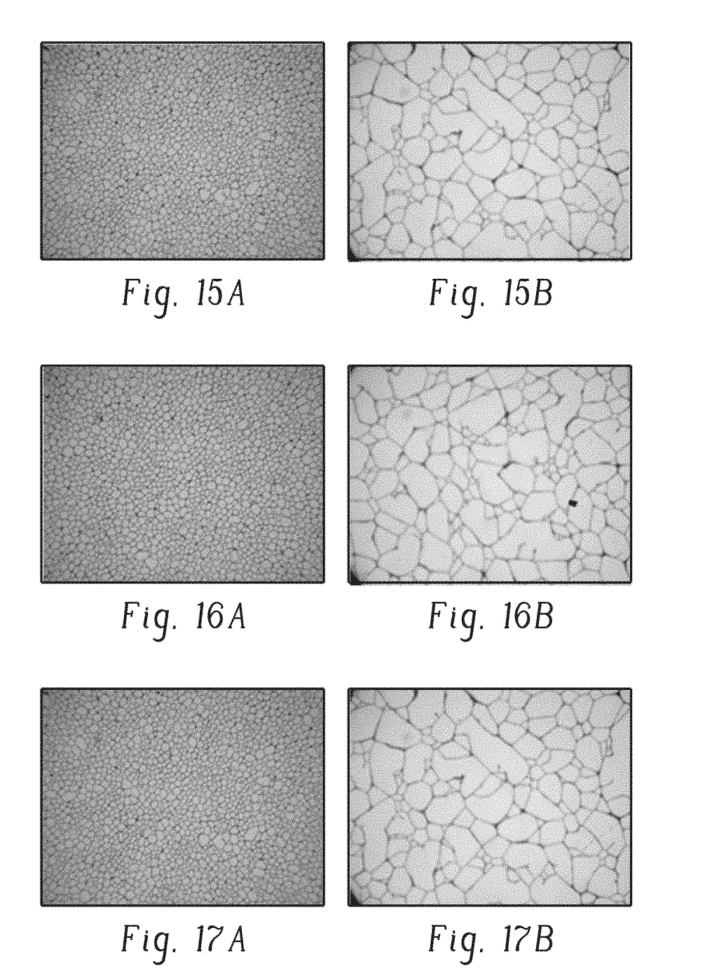

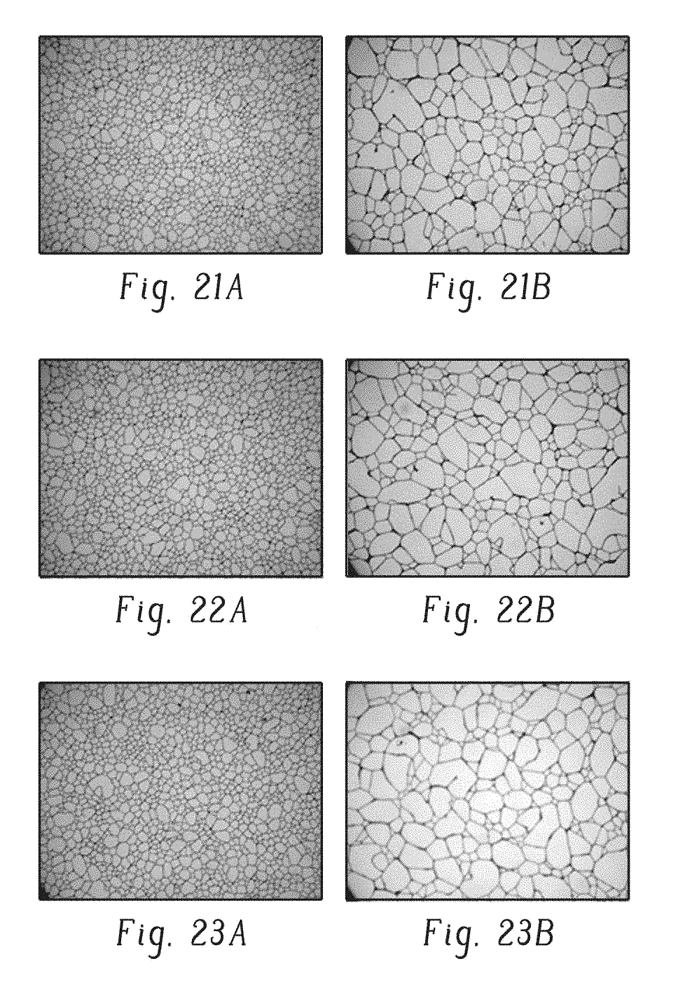

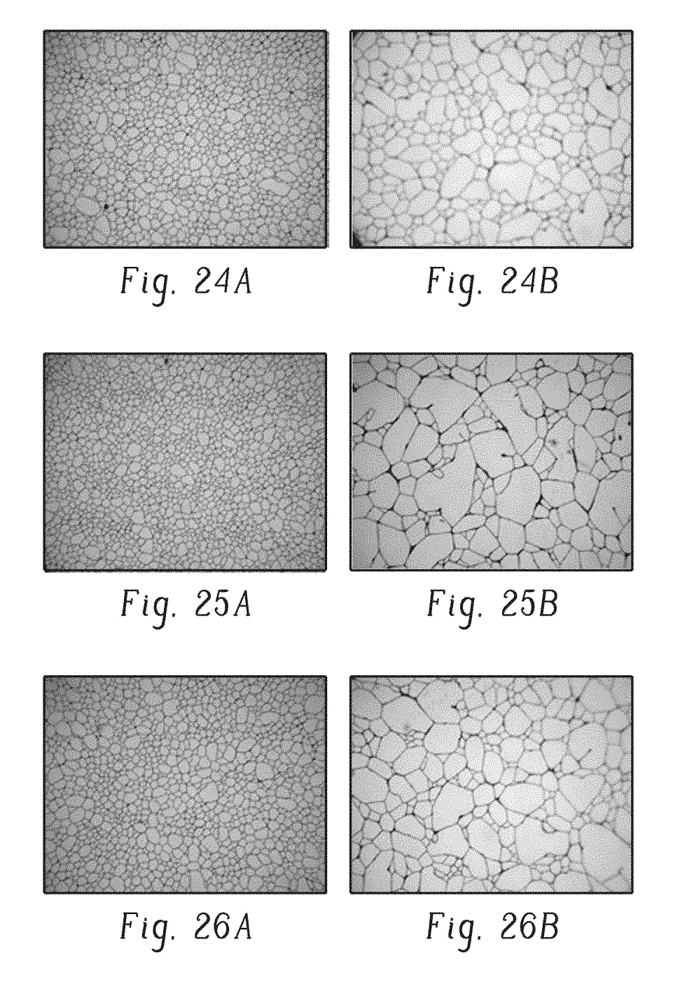

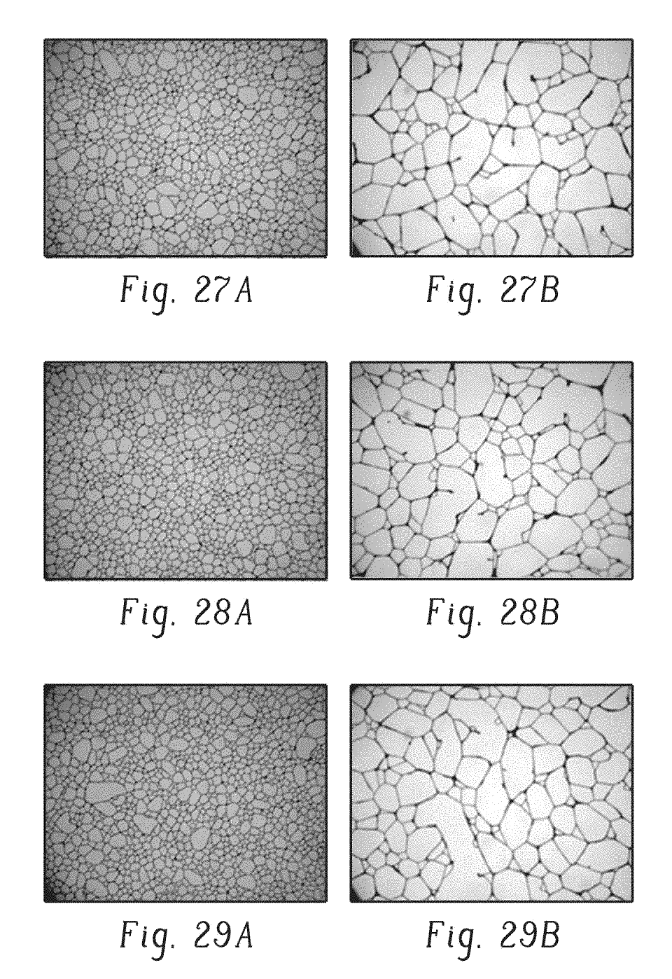

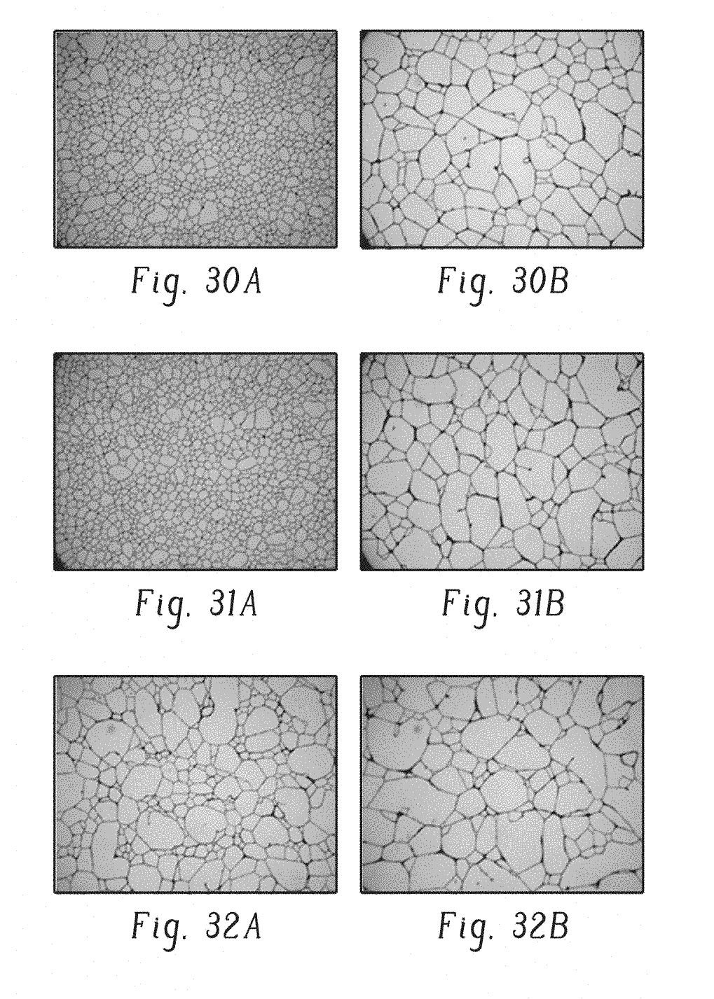

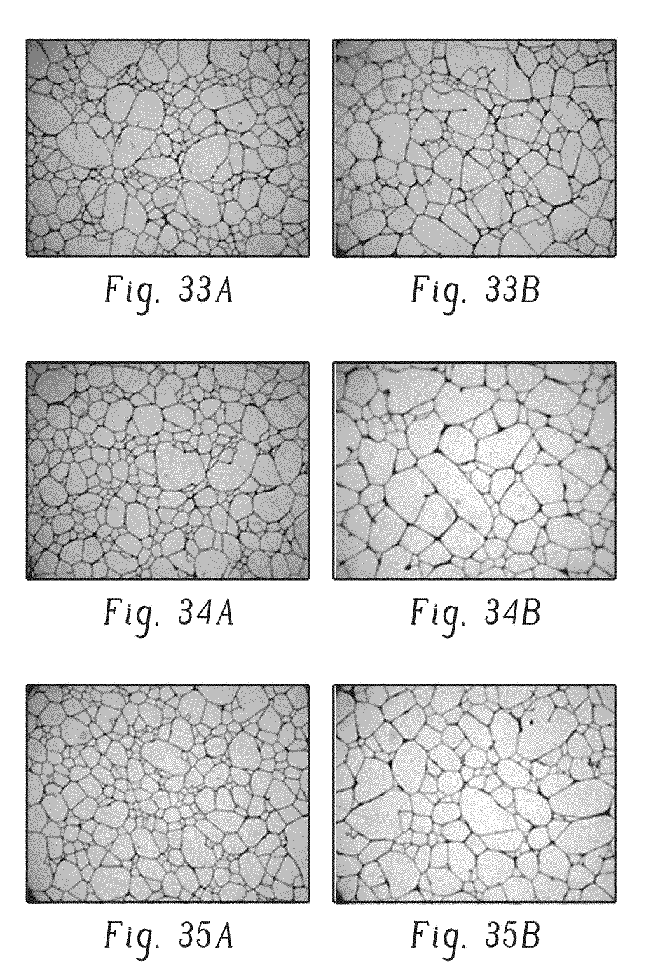

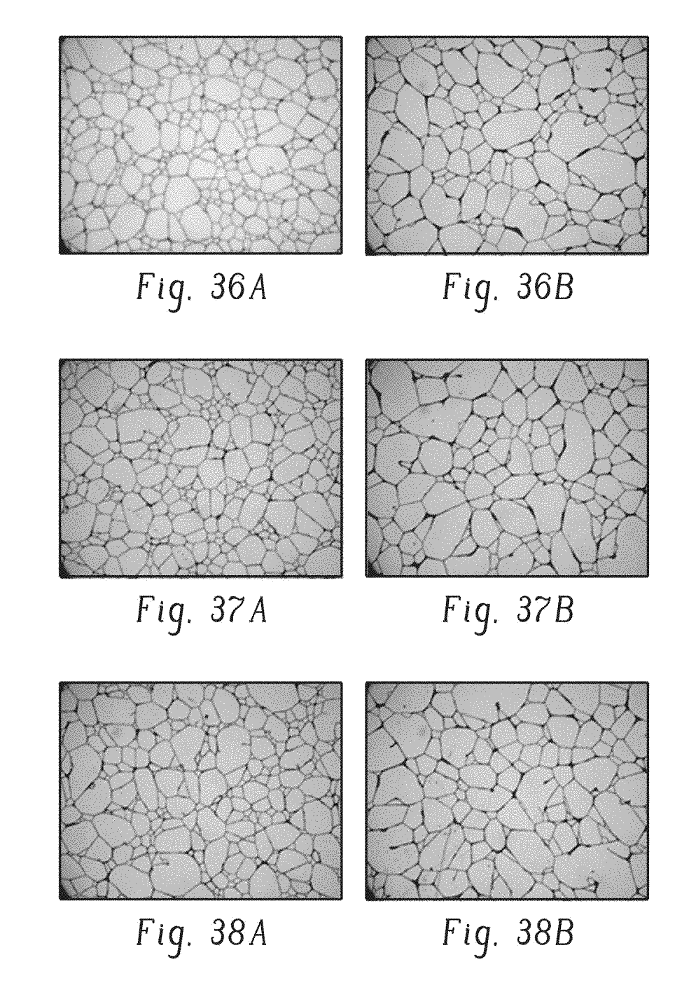

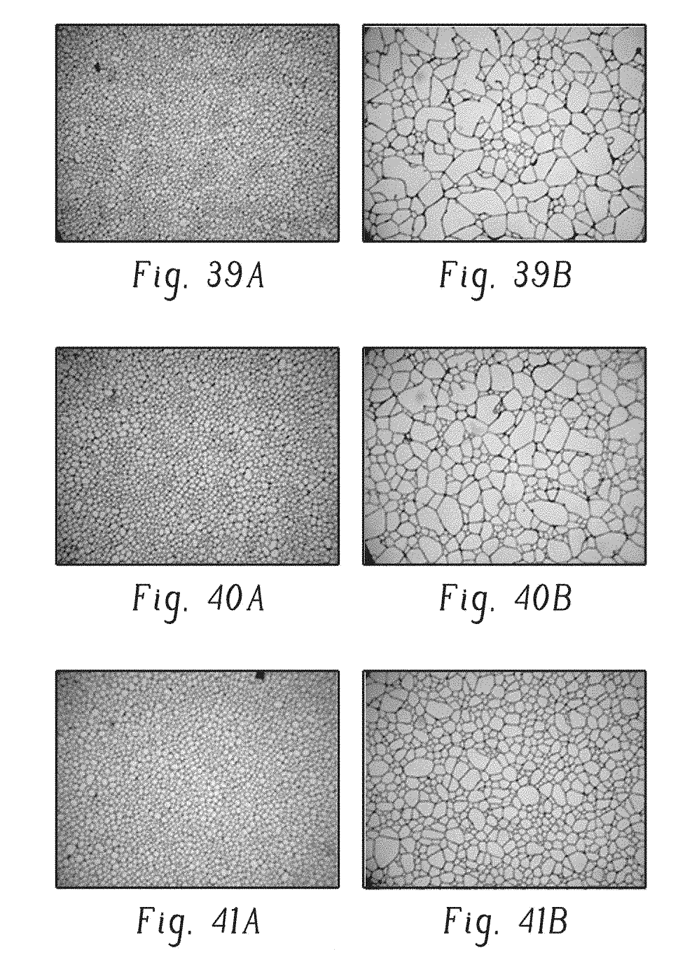

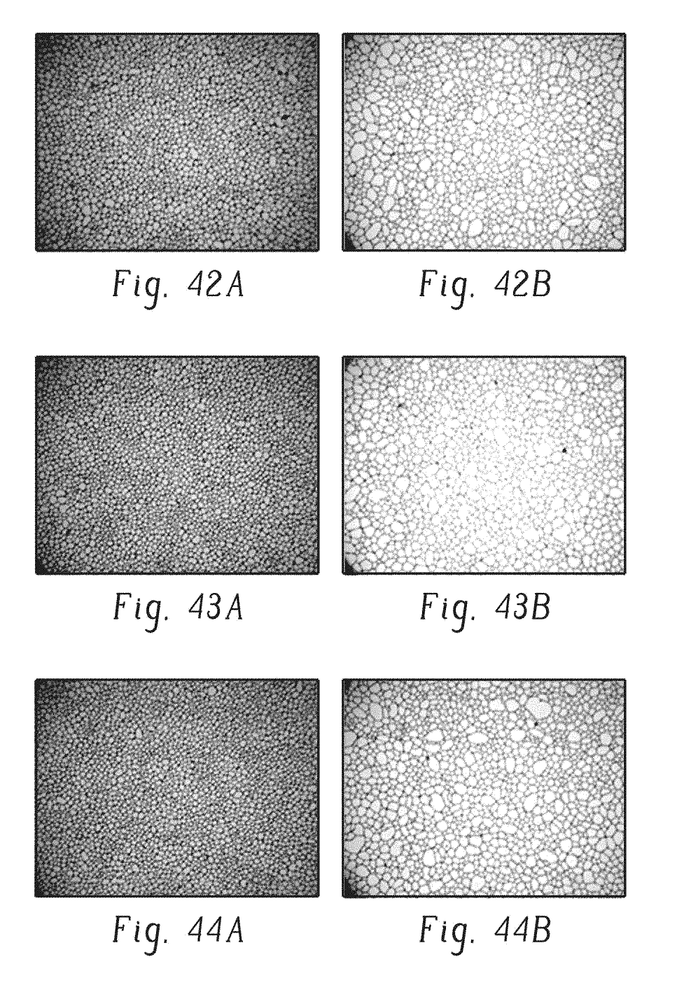

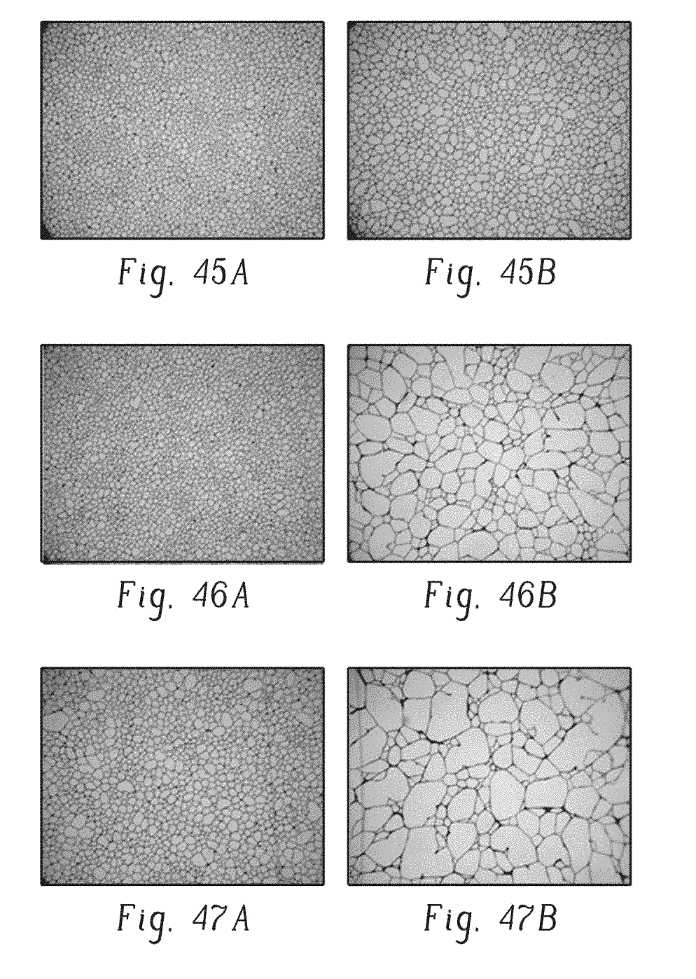

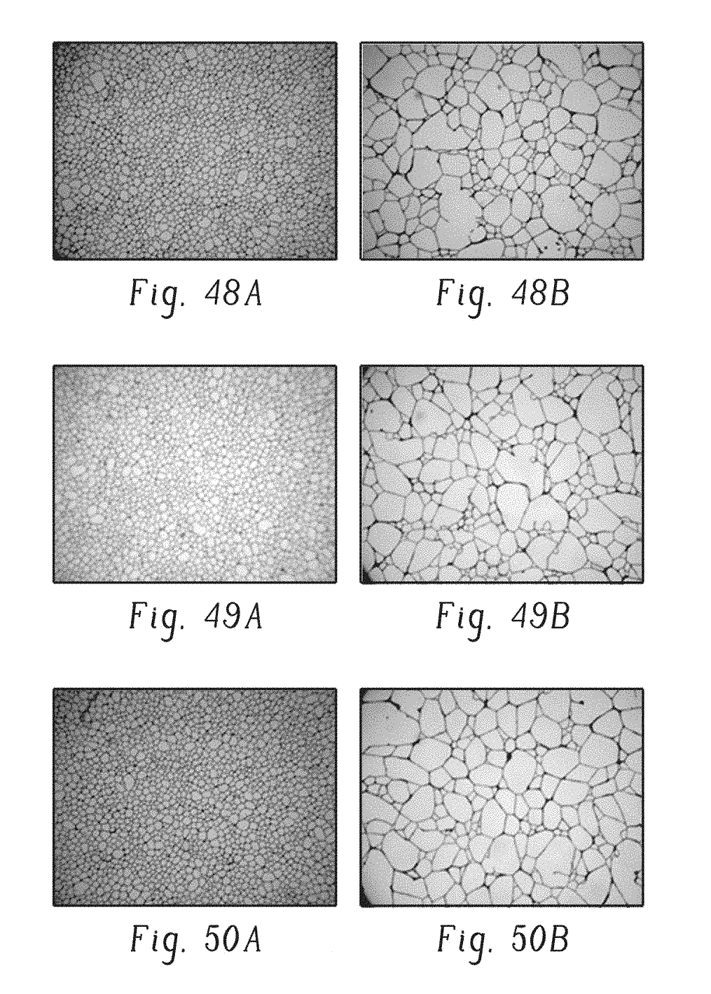

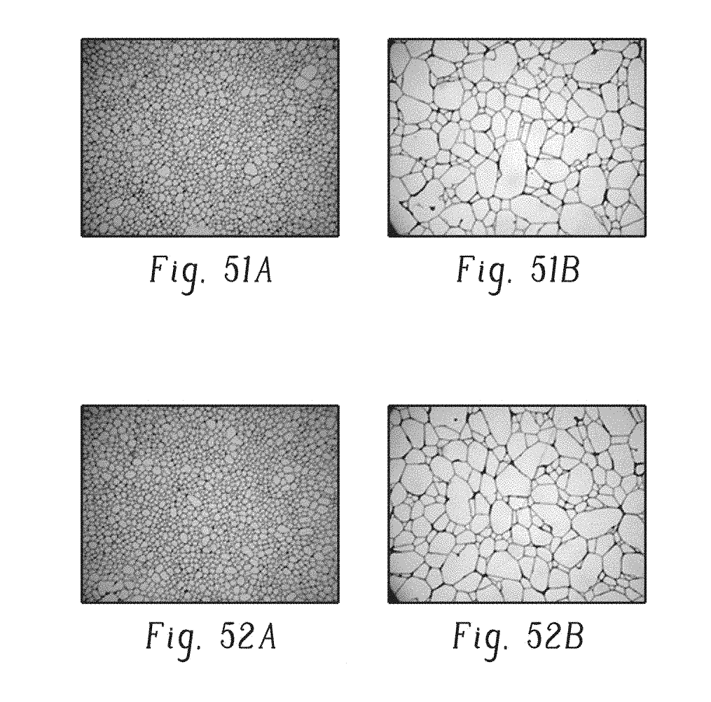

A pattern formation was performed at 1 minute at 60° C.−70° C. and then 1 minute at 120-140° C. for sintering. Sintering can assist in reducing the surface resistivity of the conductive coating. The resulting sample photos can be seen in FIGS. 11A-52B. Looking for conditions with higher LT and lower haze] The time elapsed indicates the amount of time that passed before a conductive coating was applied to the primer and the resulting conductive films were subjected to transmission, haze, and resistance testing.

TABLE 8

| Atm. | Air | | | | Inert | | | |
|---|---|---|---|---|---|---|---|---|
| H-bulb Power | Arc UV Lamp | | | | Arc UV Lamp | | | |
| Level (mJ/mW) | 589.6/616.6 | | | | 589.6/616.6 | | | |
| Primer | 2 μm | | | | 2 μm | | | |
| Thickness | | | | | | | | |
| Time Elapsed | T % | H % | R (Ω) | FIG. | T % | H % | R (Ω) | FIG. |
| 24 hours | 77.8 | 8.8 | 30 | 11A | 81.9 | 5.6 | 30 | 11B |
| 48 hours | 78.4 | 8.8 | 20 | 12A | 83.2 | 4.4 | 25 | 12B |
| 72 hours | 78.2 | 8.6 | 18 | 13A | 82.6 | 4.8 | 23 | 13B |
| 96 hours | 78.8 | 8.5 | 18 | 14A | 83.6 | 3.8 | 23 | 14B |
| 120 hours | 79.2 | 8.3 | 21 | 15A | 84.2 | 3 | 26 | 15B |
| 144 hours | 78.6 | 8.6 | 19 | 16A | 83.2 | 4.2 | 29 | 16B |
| 168 hours | 79.2 | 8.4 | 22 | 17A | 84.2 | 3.4 | 22 | 17B |

TABLE 9

| Atm. | Air | | | | Inert | | | |
|---|---|---|---|---|---|---|---|---|
| H-bulb Power | Arc UV Lamp | | | | Arc UV Lamp | | | |
| Level (mJ/mW) | 589.6/616.6 | | | | 589.6/616.6 | | | |
| Primer | 4 μm | | | | 4 μm | | | |
| Thickness | | | | | | | | |
| Time Elapsed | T % | H % | R (Ω) | FIG. | T % | H % | R (Ω) | FIG. |
| 24 hours | 80.6 | 6.2 | 46 | 18A | 85.7 | 2.3 | 42 | 18B |
| 48 hours | 80.4 | 7.2 | 48 | 19A | 84.7 | 3 | 35 | 19B |
| 72 hours | 80.9 | 6.6 | 35 | 20A | 85 | 2.8 | 33 | 20B |
| 96 hours | 81 | 7.3 | 43 | 21A | 84 | 3.5 | 30 | 21B |
| 120 hours | 81.3 | 7.7 | 37 | 22A | 83.3 | 4 | 29 | 22B |
| 144 hours | 80.9 | 7.5 | 41 | 23A | 84.4 | 3.2 | 32 | 23B |
| 168 hours | 81.3 | 7.5 | 41 | 24A | 83.3 | 3.8 | 35 | 24B |

As shown in Tables 8-9, acceptable conductive films are obtained with a low peak irradiance lamp with an inert environment (nitrogen gas) and higher coating thickness. For example, conductive films produced in the inert environment have percent transmissions greater than that of conductive films produced in an air environment. Further, the haze is significantly lower for the films produced in the inert environment that those films formed in the air environment. In addition, in comparing the examples in Table 8 that use a primer coating of 2 μm with the examples in Table 9 that use a primer coating of 4 μm, the conductive films that incorporated a thicker primer coating resulted in improved percent transmission, haze, and resistance.

TABLE 10

| Atm. | Air | | | | Inert | | | |
|---|---|---|---|---|---|---|---|---|
| H-bulb Power | Microwave UV Processor | | | | Microwave UV Processor | | | |
| Level (mJ/mW) | 412.6/2051.1 | | | | 412.6/2051.1 | | | |
| Primer | 2 μm | | | | 2 μm | | | |
| Thickness | | | | | | | | |
| Time Elapsed | T % | H % | R (Ω) | FIG. | T % | H % | R (Ω) | FIG. |
| 24 hours | 82.6 | 6 | 28 | 25A | 86.2 | 2.5 | 40 | 25B |
| 48 hours | 83.2 | 5.4 | 22 | 26A | 86.3 | 2.6 | 32 | 26B |
| 72 hours | 83.2 | 5.1 | 20 | 27A | 86.4 | 2.4 | 42 | 27B |
| 96 hours | 84 | 4.2 | 21 | 28A | 86.6 | 2.2 | 36 | 28B |
| 120 hours | 84.7 | 3.3 | 23 | 29A | 86.7 | 2 | 37 | 29B |
| 144 hours | 83.7 | 4.6 | 20 | 30A | 86.5 | 2.3 | 40 | 30B |
| 168 hours | 84.7 | 3.7 | 21 | 31A | 86.7 | 2.1 | 37 | 31B |

TABLE 11

| Atm. | Air | | | | Inert | | | |
|---|---|---|---|---|---|---|---|---|
| H-bulb Power | Microwave UV Processor | | | | Microwave UV Processor | | | |
| Level (mJ/mW) | 412.6/2051.1 | | | | 412.6/2051.1 | | | |
| Primer | 4 μm | | | | 4 μm | | | |
| Thickness | | | | | | | | |
| Time Elapsed | T % | H % | R (Ω) | FIG. | T % | H % | R (Ω) | FIG. |
| 24 hours | 85.4 | 3.1 | 60 | 32A | 86.3 | 2 | 55 | 32B |
| 48 hours | 86.2 | 2.2 | 55 | 33A | 86.1 | 1.9 | 47 | 33B |
| 72 hours | 85.1 | 2.8 | 35 | 34A | 86.5 | 1.5 | 50 | 34B |
| 96 hours | 85.1 | 2.2 | 40 | 35A | 86.5 | 1.2 | 51 | 35B |
| 120 hours | 84.8 | 1.9 | 39 | 36A | 86.7 | 0.8 | 48 | 36B |
| 144 hours | 85.2 | 2.4 | 34 | 37A | 86.4 | 1.4 | 47 | 37B |
| 168 hours | 84.8 | 2.1 | 40 | 38A | 86.7 | 1 | 47 | 38B |

In contrast to Tables 8-9 that illustrate conductive films with thicker primer coatings (4 μm) cured in an inert environment produce higher quality conductive films, Tables 10-11 illustrate that with the use of higher power Microwave UV lamp exposure even the thinner primer coating layers (2 μm) cured in an air environment are acceptable. However, the thicker (4 μm) primer coating layer results in an increase in solvent resistance. Advantageously, the film examples in Table 11 cured in an air atmosphere are stable over time, which results in a more economical conductive film as curing in an inert environment is significantly more expensive.

TABLE 12

| Atm. | Air | | | | Inert | | | |
|---|---|---|---|---|---|---|---|---|
| H-bulb Power | Microwave UV Processor | | | | Microwave UV Processor | | | |
| Level (mJ/mW) | 828.3/2086.7 | | | | 828.3/2086.7 | | | |
| Primer | 2 μm | | | | 2 μm | | | |
| Thickness | | | | | | | | |
| Time Elapsed | T % | H % | R (Ω) | FIG. | T % | H % | R (Ω) | FIG. |
| 24 hours | 77.2 | 9.4 | 33 | 39A | 85.4 | 2.8 | 36 | 39B |
| 48 hours | 77.2 | 8.8 | 26 | 40A | 85.4 | 2.8 | 31 | 40B |
| 72 hours | 77 | 8.8 | 22 | 41A | 84.7 | 3.1 | 30 | 41B |
| 96 hours | 76.9 | 8 | 25 | 42A | 84 | 3.3 | 32 | 42B |
| 120 hours | 76.8 | 7.4 | 22 | 43A | 83.3 | 3.5 | 32 | 43B |
| 144 hours | 77 | 8.3 | 27 | 44A | 84.4 | 3.2 | 33 | 44B |
| 168 hours | 76.8 | 7.7 | 31 | 45A | 83.3 | 3.4 | 34 | 45B |

TABLE 13

| Atm. | Air | | | | Inert | | | |
|---|---|---|---|---|---|---|---|---|
| H-bulb Power | Microwave UV Processor | | | | Microwave UV Processor | | | |
| Level (mJ/mW) | 828.3/2086.7 | | | | 828.3/2086.7 | | | |
| Primer | 4 μm | | | | 4 μm | | | |
| Thickness | | | | | | | | |
| Time Elapsed | T % | H % | R (Ω) | FIG. | T % | H % | R (Ω) | FIG. |
| 24 hours | 78.6 | 8.1 | 27 | 46A | 86 | 2.3 | 69 | 46B |
| 48 hours | 79.7 | 7.3 | 26 | 47A | 85.3 | 2.2 | 48 | 47B |
| 72 hours | 80..5 | 6.7 | 2.3 | 48A | 85.5 | 2.6 | 43 | 48B |
| 96 hours | 82.4 | 5.2 | 22 | 49A | 86 | 2.8 | 45 | 49B |
| 120 hours | 84.3 | 3.8 | 23 | 50A | 84.1 | 3 | 39 | 50B |
| 144 hours | 81.4 | 5.9 | 24 | 51A | 85 | 2.6 | 42 | 51B |
| 168 hours | 84.3 | 4.5 | 25 | 52A | 84.1 | 2.9 | 41 | 52B |

Tables 12-13 illustrate the effects of further increased peak irradiance levels. When the exposure time increases, the films increase in temperature, which results in an increase in oxygen that results in a detrimental surface cure. However, the samples under inert cure in Table 13 resulted in optimal films.

It was observed that the Microwave UV processor produced better results than the Arc lamp UV processor, wherein both systems used an H-bulb lamp. Not wishing to be bound by theory, it is contemplated that the amount of IR energy produced by the Arc lamp UV processor may cause defects in the primer coating due to latent evaporation during the UV exposure.

The inert curing conditions produce a higher degree of stability with lower haze than that of the air cured samples at the same exposure and peak irradiance levels. However, the results demonstrate that the four micrometer coating thickness cured at exposure and peak irradiance of the RK coater microwave lamp produces the most stable air cured conditions with acceptable optical properties.

Generally, acceptable conductive films have a percent transmission of greater than 75%, greater than 80%, greater than 85%, greater than 86%, or greater than 90%, a resistance of less than 60 ohms/square centimeter, for example, less than 55 ohms/square centimeter, or 50 ohms/square centimeter, and a percent haze of less than 5%, less than 4%, less than 3.5%, or less than 3%.

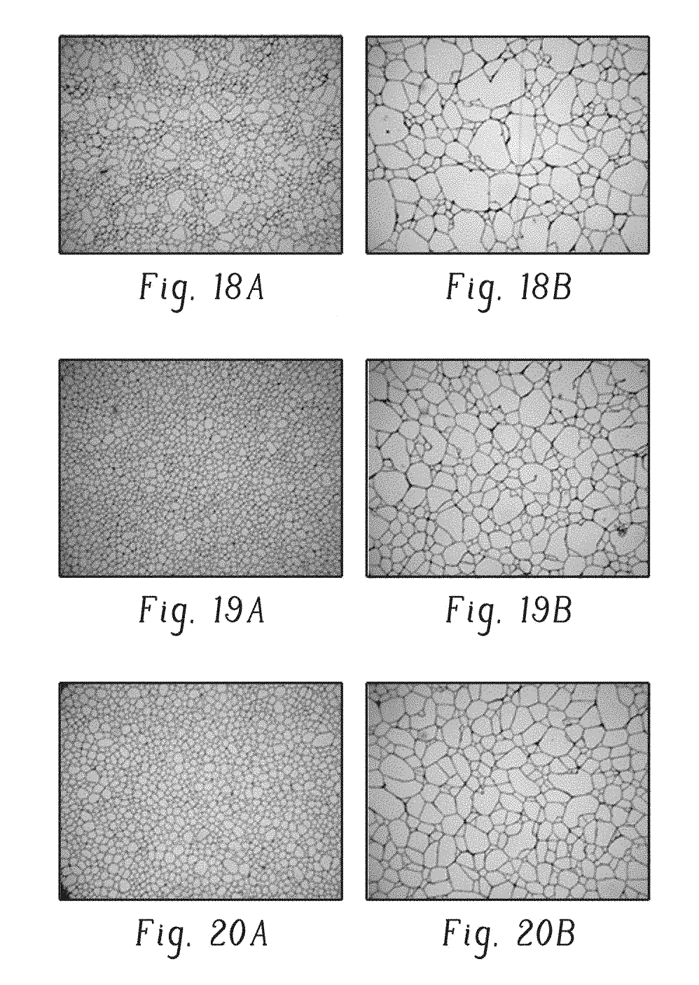

FIG. 18B, among others, is an example of an acceptable optimal pattern. As can be seen by FIGS. 25A-31A and 25B-31B, as well as the consistent values in transmission, haze, and resistance over time in Table 10, the conductive films of the present invention are stable over time. As a result, the primer coating layer adhered to the substrate does not have to immediately be coated with the conductive layer.

Unless otherwise specified herein, any reference to standards, testing methods and the like, such as ASTM D1003, ASTM D3359, ASTM D3363, refer to the standard, or method that is in force at the time of filing of the present application.

The compositions and methods of making as disclosed include at least the following embodiments:

### Embodiment 1

A primer composition for use in a conductive nanoparticle dispersion, comprising: a multifunctional acrylate oligomer; and an acrylate monomer; and a photoinitiator; and a solvent; wherein the primer composition includes a total weight, wherein 5% to 20% of the total weight comprises the multifunctional acrylate oligomer, wherein 15% to 20% of the total weight comprises the acrylate monomer, wherein 1.5% to 6% of the total weight comprises the photoinitiator; and wherein 50 to 78% of the total weight comprises the solvent.

### Embodiment 2

The primer composition of Embodiment 1, further comprising a surface additive.

### Embodiment 3

The primer composition of any of Embodiments 1-2, wherein the multifunctional acrylate oligomer comprises an aliphatic urethane acrylate oligomer, a pentaerythritol tetraacrylate, an aliphatic urethane acrylate, an acrylic ester, a dipentaerythritol dexaacrylate, an acrylated resin, a trimethylolpropane triacrylate (TMPTA), a dipentaerythritol pentaacrylate ester, or a combination comprising at least one of the foregoing.

### Embodiment 4

The primer composition of any of Embodiments 1-3, wherein the multifunctional acrylate oligomer comprises an aliphatic urethane acrylate oligomer and a pentaerythritol tetraacrylate, wherein the multifunctional acrylate oligomer includes a multifunctional acrylate oligomer weight, wherein 30% to 50% of the multifunctional acrylate oligomer weight comprises the aliphatic urethane acrylate oligomer, and wherein 50% to 70% of the multifunctional acrylate oligomer weight comprises the pentaerythritol tetraacrylate.

### Embodiment 5

The primer composition of any of Embodiments 1-4, wherein the multifunctional acrylate oligomer comprises acrylated resin.

### Embodiment 6

The primer composition of any of Embodiments 1-5, wherein the photoinitiator comprises an α-hydroxyketone photoinitiator, a bis acyl phosphine, a benzophenone photoinitiator, or a combination comprising at least one of the foregoing.

### Embodiment 7

The primer composition of Embodiment 6, wherein the α-hydroxyketone photoinitiator is 1-hydroxy-cyclohexyl-phenyl-ketone, benzophenone, 2-hydroxy-2-methyl-1-phenyl-1-propanone, or a combination comprising at least one of the foregoing.

### Embodiment 8

The primer composition of Embodiment 6, wherein the photoinitiator comprises phosphine oxide, phenyl bis(2,4,6-trimethyl benzoyl).

### Embodiment 9

The primer composition of any of Embodiments 1-8, wherein the acrylate monomer comprises monoacrylate, diacrylate, triacrylate, or a combination comprising at least one of the foregoing.

### Embodiment 10

The primer composition of Embodiment 9, wherein the acrylate monomer comprises polyethylene glycol acrylate.

### Embodiment 11

The primer composition of any of Embodiments 1-10, wherein the solvent comprises ethanol, ethyl acetate, isopropanol, isobutyl acetate, methyl ethyl ketone, methyl isobutyl ketone, or a combination comprising at least one of the foregoing.

### Embodiment 12

The primer composition of any of Embodiments 1-11, where the composition has greater than or equal to 75% transmission as measured according to ASTM D1003, Procedure A using CIE standard illuminant C.

### Embodiment 13

The primer composition of Embodiment 12, wherein the transmission is greater than or equal to 86%.

### Embodiment 14

The primer composition of any of Embodiments 1-13, wherein the primer composition has a haze value of less than or equal to 5% as measured according to ASTM D1003, Procedure A using CIE standard illuminant C.

### Embodiment 15

The primer composition of Embodiment 14, wherein the haze is less than or equal to 3%.

### Embodiment 16

The primer composition of any of Embodiments 1-15, wherein the primer composition has an electrical resistivity of less than or equal to 75 ohm/sq.

### Embodiment 17

The primer composition of Embodiment 16, wherein the electrical resistivity is less than or equal to 50 ohm/sq.

### Embodiment 18

The primer composition of any of Embodiments 1-17, wherein the primer composition can adhere to a polycarbonate substrate with an adhesion strength of greater than or equal to 3B as measured according to ASTM D3359.

### Embodiment 19

The primer composition of any of Embodiments 1-18, wherein the primer composition can adhere to a polycarbonate substrate with an adhesion strength of greater than or equal to 4B as measured according to ASTM D3359.

### Embodiment 20

The primer composition of any of Embodiments 1-19, wherein the primer composition can adhere to a polycarbonate substrate with an adhesion strength of 5B as measured according to ASTM D3359.

### Embodiment 20

A conductive sheet or film comprising: a substrate including a first surface and a second surface; a primer composition of any of the Embodiments 1-20, adhered to the first surface; and a conductive coating adjacent to the primer composition, wherein the conductive coating includes nanometer sized metal particles arranged in a network, and wherein the conductive coating has a surface resistance of less than or equal to 0.1 Ohm/sq.

### Embodiment 21

The conductive sheet or film of Embodiment 21, wherein the substrate comprises polycarbonate, poly(methyl methacrylate) (PMMA), polyethylene, glass, or a combination comprising at least one of the foregoing.

### Embodiment 22

The conductive sheet or film of any of Embodiments 21-22, wherein the sheet or film has a pencil hardness of greater than or equal to B as measured according to ASTM D3363 using a Mitsubishi Uni pencil having a 500 kilogram loading.

### Embodiment 23

The conductive sheet or film of any of Embodiments 21-23, wherein the sheet or film has a haze of less than or equal to 4% as measured according to ASTM D1003 Procedure A using CIE standard illuminant C.

### Embodiment 24

The conductive sheet or film of any of Embodiments 21-24, wherein the sheet or film has a transmittance of greater than or equal to 80% of incident light having a frequency of 430 THz to 790 THz as measured according to ASTM D1003 Procedure A using CIE standard illuminant C.

### Embodiment 25

A method of curing a coating in an inert atmosphere, comprising: forming a primer coating from a composition for use in a conductive nanoparticle composition, wherein the composition comprises a multifunctional acrylate oligomer; an acrylate monomer; a photoinitiator; and a solvent; wherein the primer composition includes a total weight, wherein 5% to 20% of the total weight comprises the multifunctional acrylate oligomer, wherein 15% to 20% of the total weight comprises the acrylate monomer, wherein 1.5% to 6% of the total weight comprises the photoinitiator; and wherein 50 to 78% of the total weight comprises the solvent; applying the primer coating to a surface of a substrate to form a coated substrate; applying irradiation to the primer coating with an ultraviolet light lamp having a peak irradiance of at least 1500 milliWatts; and curing the coating.

### Embodiment 26

The method of Embodiment 26, wherein the peak irradiance is 1500-2500 milliWatts.

### Embodiment 27

The method of any of Embodiments 26-27, wherein the curing time is 60 seconds to 180 seconds.

### Embodiment 28

The method of Embodiment 28, wherein the curing time is 120 seconds.

### Embodiment 29

The method of any of Embodiments 26-29, wherein the curing temperature is 125° C. to 200° C.

### Embodiment 30

The method of Embodiment 30, wherein the curing temperature is 140° C.

### Embodiment 31

The method of any of Embodiments 26-31, wherein the primer coating thickness is 10 micrometers to 50 micrometers

### Embodiment 32

The method of Embodiment 32, wherein the primer coating thickness is 25 micrometers.

### Embodiment 33

The method of any of Embodiments 26-33, wherein the substrate includes a protective coating on a surface opposite the surface of coating.

### Embodiment 34

The method of any of Embodiments 26-34, further comprising exposing the coated substrate to a temperature of 25° C. to 100° C. before irradiation.

### Embodiment 35

The method of Embodiment 35, wherein the exposure occurs for 30 seconds to 90 seconds.

### Embodiment 36

The method of any of Embodiments 26-36, wherein the substrate thickness is 150 micrometers to 250 micrometers.

### Embodiment 37

The method of Embodiment 37, wherein the substrate thickness is 175 micrometers.

### Embodiment 38

The method of any of Embodiments 26-38, wherein the coated substrate, after curing, has a transmittance of greater than or equal to 75% transmission as measured according to ASTM D1003, Procedure A using CIE standard illuminant C.

### Embodiment 39

The method of Embodiment 39, wherein the transmission is greater than or equal to 80%.

### Embodiment 40

The method of any of Embodiments 26-40, wherein the coated substrate, after curing, has a haze value of less than or equal to 5% as measured according to ASTM D1003, Procedure A using CIE standard illuminant C.

### Embodiment 41

The method of Embodiment 41, wherein the haze is less than or equal to 3%.

### Embodiment 42

The method of any of Embodiments 26-42, wherein the coated substrate, after curing, has an electrical resistivity of less than or equal to 75 Ohm/sq.

### Embodiment 43

The method of Embodiment 43, wherein the electrical resistivity is less than or equal to 50 ohm/sq.

### Embodiment 44

The method of any of Embodiments 26-44, wherein the coated substrate, after curing, adheres to a polycarbonate substrate with an adhesion strength of greater than or equal to 4B as measured according to ASTM D3359.

### Embodiment 45

The method of any of Embodiments 26-45, wherein the coated substrate, after curing, adheres to a polycarbonate substrate with an adhesion strength of 5B as measured according to ASTM D3359.

### Embodiment 46

A conductive sheet or film comprising: a coated substrate, wherein the coated substrate includes a first surface and a second surface, wherein the primer coating is adhered to the first surface; and a conductive coating adjacent to the primer composition, wherein the conductive coating includes nanometer sized metal particles arranged in a network, and wherein the conductive coating has a surface resistance of less than or equal to 0.1 Ohm/sq.

### Embodiment 47

The conductive sheet or film of Embodiment 47, wherein the substrate comprises polycarbonate, poly(methyl methacrylate) (PMMA), polyethylene, glass, or a combination comprising at least one of the foregoing.

### Embodiment 48

The conductive sheet or film of any of Embodiments 47-48, wherein the sheet or film has a pencil hardness of greater than or equal to H as measured according to ASTM D3363 using a Mitsubishi Uni pencil having a 1 kilogram loading.

### Embodiment 49

The conductive sheet or film of any of Embodiments 47-49, wherein the sheet or film has a haze of less than or equal to 6% as measured according to ASTM D1003 Procedure A using CIE standard illuminant C.

### Embodiment 50

The conductive sheet or film of any of Embodiments 47-50, wherein the sheet or film has a transmittance of greater than or equal to 80% of incident light having a frequency of 430 THz to 790 THz as measured according to ASTM D1003 Procedure A using CIE standard illuminant C.

### Embodiment 51

The conductive sheet or film of any of Embodiments 47-51, wherein the sheet or film has a change in surface resistivity of less than or equal to 4 ohms after it is boiled in water for 2 hours as measured according to ASTM D257.

### Embodiment 52

A method of forming the conductive sheet or film of any of Embodiments 47-52, comprising: forming a primer coating from a composition for use in a conductive nanoparticle composition, wherein the composition comprises a multifunctional acrylate oligomer; an acrylate monomer; a photoinitiator; and a solvent; wherein the primer composition includes a total weight, wherein 5% to 20% of the total weight comprises the multifunctional acrylate oligomer, wherein 15% to 20% of the total weight comprises the acrylate monomer, wherein 1.5% to 6% of the total weight comprises the photoinitiator; and wherein 50 to 78% of the total weight comprises the solvent; applying the primer coating to a surface of a substrate to form a coated substrate; applying irradiation to the primer coating with an ultraviolet light lamp having a peak irradiance of at least 600 milliWatts in an inert atmosphere; and curing the coating.

### Embodiment 54

The method of Embodiment 53, wherein the inert atmosphere comprises a gas selected from nitrogen, argon, helium, carbon dioxide, or a combination comprising at least one of the foregoing.

### Embodiment 55

The method of Embodiment 54, wherein the inert atmosphere comprises nitrogen.

### Embodiment 56

A method of forming the conductive sheet or film of any of Embodiments 47-52 including a nanoparticle dispersion, comprising: forming a primer coating from a composition for use in a conductive nanoparticle composition, wherein the composition comprises a multifunctional acrylate oligomer; an acrylate monomer; a photoinitiator; and a solvent; wherein the primer composition includes a total weight, wherein 5% to 20% of the total weight comprises the multifunctional acrylate oligomer, wherein 15% to 20% of the total weight comprises the acrylate monomer, wherein 1.5% to 6% of the total weight comprises the photoinitiator; and wherein 50 to 78% of the total weight comprises the solvent; applying the primer coating to a first surface of a substrate to form a coated substrate; applying irradiation to the primer coating with a microwave powered ultraviolet light lamp, wherein irradiation is applied in the inert atmosphere; curing the coating forming a cured, coated substrate; aging the cured, coated substrate; applying a conductive coating to the coated substrate on the first substrate of the surface; and pressing the coated substrate and the conductive coating together to form a stack, wherein the primer coating is disposed therebetween; and curing the conductive coating to the coated substrate by heating the stack, wherein the primer coating and the conductive coating remain adhered to the coated substrate.

### Embodiment 57

The method of Embodiment 56, comprising applying a protective material to a surface of the conductive substrate.

### Embodiment 58

The method of any of Embodiments 56-57, comprising trimming the conductive substrate.

### Embodiment 59

The method of any of Embodiments 56-58, wherein pressing comprises roller pressing, belt pressing, double belt pressing, stamping, die pressing, or a combination comprising at least one of the foregoing.

### Embodiment 60

The method of any of Embodiments 56-59, wherein the heating further comprises heating to greater than 70° C.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A primer composition for use in a conductive nanoparticle dispersion, comprising:
a multifunctional acrylate oligomer; and
an acrylate monomer; and
a photoinitiator; and
a solvent;
wherein the primer composition includes a total weight, wherein 5% to 20% of the total weight comprises the multifunctional acrylate oligomer, wherein 15% to 20% of the total weight comprises the acrylate monomer, wherein 1.5% to 6% of the total weight comprises the photoinitiator; and wherein 50 to 78% of the total weight comprises the solvent.

2. The primer composition of claim 1, wherein the multifunctional acrylate oligomer comprises an aliphatic urethane acrylate oligomer, a pentaerythritol tetraacrylate, an aliphatic urethane acrylate, an acrylic ester, a dipentaerythritol dexaacrylate, an acrylated resin, a trimethylolpropane triacrylate (TMPTA), a dipentaerythritol pentaacrylate ester, or a combination comprising at least one of the foregoing.

3. The primer composition of claim 1, wherein the photoinitiator comprises an α-hydroxyketone photoinitiator, a bis acyl phosphine, a benzophenone photoinitiator, or a combination comprising at least one of the foregoing.

4. The primer composition of claim 1, wherein the acrylate monomer comprises monoacrylate, diacrylate, triacrylate, or a combination comprising at least one of the foregoing.

5. The primer composition of claim 1, wherein the solvent comprises ethanol, ethyl acetate, isopropanol, isobutyl acetate, methyl ethyl ketone, methyl isobutyl ketone, or a combination comprising at least one of the foregoing.

6. The primer composition of claim 1, where the composition has greater than or equal to 75% transmission as measured according to ASTM D1003, Procedure A using CIE standard illuminant C.

7. The primer composition of claim 1, wherein the primer composition has a haze value of less than or equal to 5% as measured according to ASTM D1003, Procedure A using CIE standard illuminant C.

8. The primer composition of claim 1, wherein the primer composition has an electrical resistivity of less than or equal to 75 ohm/sq claim 1.

9. A method of curing a coating, comprising:
forming a primer coating from a composition for use in a conductive nanoparticle composition, wherein the composition comprises a multifunctional acrylate oligomer; an acrylate monomer; a photoinitiator; and a solvent; wherein the primer composition includes a total weight, wherein 5% to 20% of the total weight comprises the multifunctional acrylate oligomer, wherein 15% to 20% of the total weight comprises the acrylate monomer, wherein 1.5% to 6% of the total weight comprises the photoinitiator; and wherein 50 to 78% of the total weight comprises the solvent;
applying the primer coating to a surface of a substrate to form a coated substrate;
applying irradiation to the primer coating with an ultraviolet light lamp having a peak irradiance of at least 1500 milliWatts; and
curing the coating.

10. The method of claim 9, wherein the peak irradiance is 1500-2500 milliWatts.

11. The method of claim 9, wherein the curing time is 60 seconds to 180 seconds.

12. The method of claim 9, wherein the curing temperature is 125° C. to 200° C.

13. The method of claim 9, wherein the primer coating thickness is 10 micrometers to 50 micrometers.

14. A conductive sheet or film, comprising:
a coated substrate, wherein the coated substrate includes a first surface and a second surface, wherein the primer coating is adhered to the first surface; and
a conductive coating adjacent to the primer composition, wherein the conductive coating includes nanometer sized metal particles arranged in a network, and wherein the conductive coating has a surface resistance of less than or equal to 0.1 Ohm/sq.

15. The conductive sheet or film of claim 14, wherein the substrate comprises polycarbonate, poly(methyl methacrylate) (PMMA), polyethylene, glass, or a combination comprising at least one of the foregoing.

16. The conductive sheet or film of claim 14, wherein the sheet or film has a haze of less than or equal to 4% as measured according to ASTM D1003 Procedure A using CIE standard illuminant C.

17. A method of forming the conductive sheet or film of claim 14, comprising:
forming a primer coating from a composition for use in a conductive nanoparticle composition, wherein the composition comprises a multifunctional acrylate oligomer; an acrylate monomer; a photoinitiator; and a solvent; wherein the primer composition includes a total weight, wherein 5% to 20% of the total weight comprises the multifunctional acrylate oligomer, wherein 15% to 20% of the total weight comprises the acrylate monomer, wherein 1.5% to 6% of the total weight comprises the photoinitiator; and wherein 50 to 78% of the total weight comprises the solvent;
applying the primer coating to a surface of a substrate to form a coated substrate;
applying irradiation to the primer coating with an ultraviolet light lamp having a peak irradiance of at least 600 milliWatts in an inert atmosphere; and
curing the coating.

18. The method of claim 17, wherein the inert atmosphere comprises a gas selected from nitrogen, argon, helium, carbon dioxide, or a combination comprising at least one of the foregoing.

19. A method of forming the conductive sheet or film of claim 14 a nanoparticle dispersion, comprising:
forming a primer coating from a composition for use in a conductive nanoparticle composition, wherein the composition comprises a multifunctional acrylate oligomer; an acrylate monomer; a photoinitiator; and a solvent; wherein the primer composition includes a total weight, wherein 5% to 20% of the total weight comprises the multifunctional acrylate oligomer, wherein 15% to 20% of the total weight comprises the acrylate monomer, wherein 1.5% to 6% of the total weight comprises the photoinitiator; and wherein 50 to 78% of the total weight comprises the solvent;
applying the primer coating to a first surface of a substrate to form a coated substrate;
applying irradiation to the primer coating with a microwave powered ultraviolet light lamp, wherein irradiation is applied in the inert atmosphere;
curing the coating forming a cured, coated substrate
aging the cured, coated substrate;
applying a conductive coating to the coated substrate on the first substrate of the surface; and
pressing the coated substrate and the conductive coating together to form a stack, wherein the primer coating is disposed therebetween; and
curing the conductive coating to the coated substrate by heating the stack, wherein the primer coating and the conductive coating remain adhered to the coated substrate.

20. The method of claim 19, comprising applying a protective material to a surface of the conductive substrate.
